(19) United States
(12) Patent Application Publication
(10) Pub. No.: US 2025/0023486 A1
(43) Pub. Date: Jan. 16, 2025

(54) ELECTRIC POWER CONVERSION APPARATUS AND ELECTRIC POWER CONVERSION SYSTEM

(71) Applicant: TDK CORPORATION, Tokyo (JP)

(72) Inventors: Kenta TERADA, Tokyo (JP); Takamichi SUGAWARA, Tokyo (JP); Kazuki MATSUBARA, Tokyo (JP)

(73) Assignee: TDK CORPORATION, Tokyo (JP)

(21) Appl. No.: 18/760,925

(22) Filed: Jul. 1, 2024

(30) Foreign Application Priority Data
Jul. 10, 2023 (JP) 2023-113015

(51) Int. Cl. H02M 7/219; H02J 7/00; H02M 1/15

(52) U.S. Cl. CPC H02M 7/219; H02J 7/0019; H02J 7/007182; H02M 1/15; H02J 2207/20

(57) ABSTRACT

An electric power conversion apparatus includes: a first electric power terminal; a switching circuit including a switching device; a transformer including first and second windings; a rectifying circuit including a switching device; a smoothing circuit; a second electric power terminal; a control circuit, and a driving circuit. The control circuit is configured to perform a first operation and a second operation alternately before causing electric power to be supplied from the first electric power terminal toward the second electric power terminal, and is configured to control operations of the switching circuit and the rectifying circuit to cause, in the first operation, first electric power to be supplied from the second electric power terminal to the first electric power terminal, and to cause, in the second operation, second electric power lower than the first electric power to be supplied from the second electric power terminal to the first electric power terminal.

### CROSS-REFERENCE TO RELATED APPLICATIONS

The present application claims priority from Japanese Patent Application No. 2023-113015 filed on Jul. 10, 2023, the entire contents of which are hereby incorporated by reference.

### BACKGROUND

The disclosure relates to an electric power conversion apparatus and an electric power conversion system that each convert electric power.

Some of electric power conversion apparatuses that convert electric power of a primary-side battery and supply the converted electric power to a secondary-side battery perform what is called a precharge operation before performing an electric power conversion operation. The precharge operation refers to an operation of supplying electric power of the secondary-side battery to a primary-side capacitor via the electric power conversion apparatus. For example, Japanese Unexamined Patent Application Publication No. 2017-034959 discloses a technique in which, when stepping up a voltage of a capacitor by performing a precharge, a period in which a switching operation is to be performed and a period in which the switching operation is to be stopped are provided alternately.

### SUMMARY

An electric power conversion apparatus according to an embodiment of the disclosure includes a first electric power terminal, a switching circuit, a transformer, a rectifying circuit, a smoothing circuit, a second electric power terminal, a control circuit, and a driving circuit. The switching circuit is coupled to the first electric power terminal and includes a switching device. The switching device is configured to perform a switching operation, based on a first driving signal. The transformer includes a first winding and a second winding. The first winding is coupled to the switching circuit. The rectifying circuit is coupled to the second winding and includes a switching device. The switching device is configured to perform a switching operation, based on a second driving signal. The smoothing circuit is coupled to the rectifying circuit. The second electric power terminal is coupled to the smoothing circuit. The control circuit is configured to control operations of the switching circuit and the rectifying circuit. The driving circuit is configured to generate the first driving signal and the second driving signal, based on an instruction from the control circuit. The control circuit is configured to: perform a first operation and a second operation alternately before causing electric power to be supplied from the first electric power terminal toward the second electric power terminal; control, in the first operation, the operations of the switching circuit and the rectifying circuit to cause first electric power to be supplied from the second electric power terminal to the first electric power terminal to increase a voltage at the first electric power terminal; and control, in the second operation, the operations of the switching circuit and the rectifying circuit to cause second electric power lower than the first electric power to be supplied from the second electric power terminal to the first electric power terminal to decrease the voltage at the first electric power terminal.

An electric power conversion system according to an embodiment of the disclosure includes a first battery, a capacitor, a first switch, a second switch, an electric power conversion apparatus, and a second battery. The first battery includes a first terminal and a second terminal. The capacitor includes a first terminal and a second terminal. The first switch is provided on a path coupling the first terminal of the first battery and the first terminal of the capacitor to each other. The second switch is provided on a path coupling the second terminal of the first battery and the second terminal of the capacitor to each other. The electric power conversion apparatus includes a first electric power terminal, a switching circuit, a transformer, a rectifying circuit, a smoothing circuit, a second electric power terminal, a control circuit, and a driving circuit. The first electric power terminal includes a first coupling terminal and a second coupling terminal. The first coupling terminal is coupled to the first terminal of the capacitor. The second coupling terminal is coupled to the second terminal of the capacitor. The switching circuit is coupled to the first electric power terminal and includes a switching device. The switching device is configured to perform a switching operation, based on a first driving signal. The transformer includes a first winding and a second winding. The first winding is coupled to the switching circuit. The rectifying circuit is coupled to the second winding and includes a switching device. The switching device is configured to perform a switching operation, based on a second driving signal. The smoothing circuit is coupled to the rectifying circuit. The second electric power terminal is coupled to the smoothing circuit and to the second battery. The control circuit is configured to control operations of the switching circuit and the rectifying circuit. The driving circuit is configured to generate the first driving signal and the second driving signal, based on an instruction from the control circuit. The control circuit is configured to: perform a first operation and a second operation alternately before causing electric power to be supplied from the first electric power terminal toward the second electric power terminal; control, in the first operation, the operations of the switching circuit and the rectifying circuit to cause first electric power to be supplied from the second electric power terminal to the first electric power terminal to increase a voltage at the first electric power terminal; and control, in the second operation, the operations of the switching circuit and the rectifying circuit to cause second electric power lower than the first electric power to be supplied from the second electric power terminal to the first electric power terminal to decrease the voltage at the first electric power terminal.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of an electric power conversion system according to one example embodiment of the disclosure.

FIG. 2 is a block diagram illustrating a configuration example of an auxiliary power supply circuit illustrated in FIG. 1.

FIG. 3 is a block diagram illustrating a configuration example of a control circuit illustrated in FIG. 1.

FIG. 4 is an explanatory diagram illustrating an operation example of a threshold generator illustrated in FIG. 3.

FIG. 5 is an explanatory diagram illustrating a characteristic example of a comparison operation of a comparator illustrated in FIG. 3.

FIG. 6 is a timing chart illustrating an operation example of the comparator illustrated in FIG. 3.

FIG. 7 is a timing chart illustrating an example of a precharge operation of the electric power conversion system illustrated in FIG. 1.

FIG. 8 is a timing waveform chart illustrating an example of gate signals of the electric power conversion system illustrated in FIG. 1 in a precharge period.

FIG. 9 is a timing waveform chart illustrating an example of the precharge operation of the electric power conversion system illustrated in FIG. 1.

FIG. 10 is a timing waveform chart illustrating an example of the gate signals of the electric power conversion system illustrated in FIG. 1 in a voltage-maintaining period.

FIG. 11 is a timing waveform chart illustrating an operation example of the electric power conversion system illustrated in FIG. 1 in the voltage-maintaining period.

FIG. 12 is a timing waveform chart illustrating an operation example of an electric power conversion system according to a reference example in the voltage-maintaining period.

FIG. 13 is a timing chart illustrating an example of the precharge operation of an electric power conversion system according to a modification example.

FIG. 14 is a timing waveform chart illustrating an example of the gate signals of an electric power conversion system according to another modification example in the voltage-maintaining period.

FIG. 15 is a timing waveform chart illustrating an example of the gate signals of an electric power conversion system according to another modification example in the voltage-maintaining period.

FIG. 16 is a circuit diagram illustrating a configuration example of an electric power conversion system according to another modification example.

### DETAILED DESCRIPTION

In an electric power conversion apparatus that performs a precharge operation, a voltage of a primary-side capacitor is maintained after being stepped up. It is desired that the voltage of the primary-side capacitor be small in ripple over a period of time during which the voltage is maintained.

It is desirable to provide an electric power conversion apparatus and an electric power conversion system that each make it possible to reduce a ripple of a voltage.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.

### Example Embodiment

### [Configuration Example]

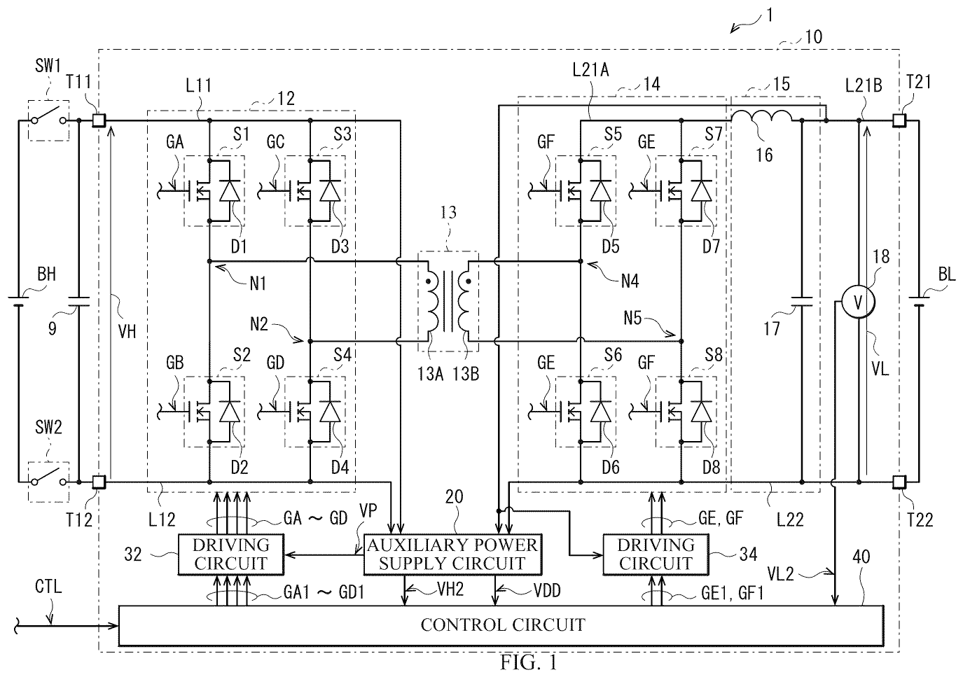

FIG. 1 illustrates a configuration example of an electric power conversion system 1 including an electric power conversion apparatus according to an example embodiment of the disclosure. The electric power conversion system 1 may include a high voltage battery BH, switches SW1 and SW2, a capacitor 9, an electric power conversion apparatus 10, and a low voltage battery BL. The electric power conversion system 1 may be configured to convert electric power supplied from the high voltage battery BH and to supply the converted electric power to the low voltage battery BL.

The high voltage battery BH may be configured to store electric power. The high voltage battery BH may supply the electric power to the electric power conversion apparatus 10 via the switches SW1 and SW2.

The switches SW1 and SW2 may be configured to supply the electric power stored in the high voltage battery BH to the electric power conversion apparatus 10 by being turned on. The switches SW1 and SW2 may each include a relay, for example. The switch SW1 may couple a positive terminal of the high voltage battery BH and a terminal T11 of the electric power conversion apparatus 10 to each other by being turned on. The switch SW2 may couple a negative terminal of the high voltage battery BH and a terminal T12 of the electric power conversion apparatus 10 to each other by being turned on. The switches SW1 and SW2 may be turned on and off in accordance with instructions from an unillustrated system control processor.

The capacitor 9 may have a first end coupled to the terminal T11 of the electric power conversion apparatus 10 and to the switch SW1, and a second end coupled to the terminal T12 of the electric power conversion apparatus 10 and to the switch SW2.

The electric power conversion apparatus 10 may be configured to step down a voltage received from the high voltage battery BH to thereby convert the electric power, and to supply the converted electric power to the low voltage battery BL. The electric power conversion apparatus 10 may include the terminals T11 and T12, a switching circuit 12, a transformer 13, a rectifying circuit 14, a smoothing circuit 15, a voltage sensor 18, an auxiliary power supply circuit 20, driving circuits 32 and 34, a control circuit 40, and terminals T21 and T22. Primary-side circuitry of the electric power conversion system 1 may include the high voltage battery BH, the switches SW1 and SW2, the capacitor 9, the switching circuit 12, and the driving circuit 32. Secondary-side circuitry of the electric power conversion system 1 may include the rectifying circuit 14, the smoothing circuit 15, the voltage sensor 18, the driving circuit 34, and the low voltage battery BL.

The terminals T11 and T12 may be configured to receive a voltage from the high voltage battery BH upon turning-on of the switches SW1 and SW2. In the electric power conversion apparatus 10, the terminal T11 may be coupled to a voltage line L11, and the terminal T12 may be coupled to a reference voltage line L12. A voltage at the voltage line L11 with respect to a voltage at the reference voltage line L12 may be a voltage VH.

The switching circuit 12 may be configured to convert a direct-current voltage supplied from the high voltage battery BH into an alternating-current voltage. The switching circuit 12 may be a full-bridge circuit, and may include transistors S1 to S4. The transistors S1 to S4 may be switching devices that perform switching operations, respectively based on gate signals GA to GD. The transistors S1 to S4 may each include an N-type field-effect transistor (FET), for example. The transistors S1 to S4 may respectively include body diodes D1 to D4. For example, the body diode D1 may have an anode coupled to a source of the transistor S1, and a cathode coupled to a drain of the transistor S1. This similarly applies to the body diodes D2 to D4. Note that such a configuration is non-limiting. In some embodiments, an external diode device may be provided between the drain and the source of each of the transistors S1 to S4. Although the N-type field-effect transistor may be used in this example embodiment, this is non-limiting, and any kind of switching device may be used.

The transistor S1 may be provided on a path coupling the voltage line L11 and a node N1 to each other, and may be configured to couple the node N1 to the voltage line L11 by being turned on. The drain of the transistor S1 may be coupled to the voltage line L1, agate of the transistor S1 may receive the gate signal GA, and the source of the transistor S1 may be coupled to the node N1. The transistor S2 may be provided on a path coupling the node N1 and the reference voltage line L12 to each other, and may be configured to couple the node N1 to the reference voltage line L12 by being turned on. The drain of the transistor S2 may be coupled to the node N1, a gate of the transistor S2 may receive the gate signal GB, and the source of the transistor S2 may be coupled to the reference voltage line L12. The node N1 may be a coupling point between the source of the transistor S1 and the drain of the transistor S2.

The transistor S3 may be provided on a path coupling the voltage line L11 and a node N2 to each other, and may be configured to couple the node N2 to the voltage line L11 by being turned on. The drain of the transistor S3 may be coupled to the voltage line L11, a gate of the transistor S3 may receive the gate signal GC, and the source of the transistor S3 may be coupled to the node N2. The transistor S4 may be provided on a path coupling the node N2 and the reference voltage line L12 to each other, and may be configured to couple the node N2 to the reference voltage line L12 by being turned on. The drain of the transistor S4 may be coupled to the node N2, a gate of the transistor S4 may receive the gate signal GD, and the source of the transistor S4 may be coupled to the reference voltage line L12. The node N2 may be a coupling point between the source of the transistor S3 and the drain of the transistor S4.

The transformer 13 may be configured to provide direct-current isolation and alternating-current coupling between the primary-side circuitry and the secondary-side circuitry, and to convert an alternating-current voltage supplied from the primary-side circuitry with a transformation ratio N of the transformer 13 to thereby supply the converted alternating-current voltage to the secondary-side circuitry. The transformer 13 may include windings 13A and 13B. The winding 13A may be a primary winding. The winding 13A may have a first end coupled to the node N1 in the switching circuit 12, and a second end coupled to the node N2 in the switching circuit 12. The winding 13B may be a secondary winding. The winding 13B may have a first end coupled to a node N4 in the rectifying circuit 14, and a second end coupled to a node N5 in the rectifying circuit 14. The nodes N4 and N5 will be described later.

The rectifying circuit 14 may be configured to rectify the alternating-current voltage outputted from the winding 13B of the transformer 13. The rectifying circuit 14 may be a full-bridge circuit, and may include transistors S5 to S8. The transistors S5 to S8 may each be configured to perform a switching operation, based on a gate signal GE or GF. The transistors S5 to S8 may each include, for example, an N-type field-effect transistor, as with each of the transistors S1 to S4 of the switching circuit 12. The transistors S5 to S8 may respectively include body diodes D5 to D8, as with the transistors S1 to S4.

The transistor S5 may be provided on a path coupling a voltage line L21A and the node N4 to each other, and may be configured to couple the node N4 to the voltage line L21A by being turned on. The transistor S5 may have a drain coupled to the voltage line L21A, a gate to receive the gate signal GF, and a source coupled to the node N4. The transistor S6 may be provided on a path coupling the node N4 and a reference voltage line L22 to each other, and may be configured to couple the node N4 to the reference voltage line L22 by being turned on. The transistor S6 may have a drain coupled to the node N4, a gate to receive the gate signal GE, and a source coupled to the reference voltage line L22. The node N4 may be a coupling point between the source of the transistor S5 and the drain of the transistor S6.

The transistor S7 may be provided on a path coupling the voltage line L21A and the node N5 to each other, and may be configured to couple the node N5 to the voltage line L21A by being turned on. The transistor S7 may have a drain coupled to the voltage line L21A, a gate to receive the gate signal GE, and a source coupled to the node N5. The transistor S8 may be provided on a path coupling the node N5 and the reference voltage line L22 to each other, and may be configured to couple the node N5 to the reference voltage line L22 by being turned on. The transistor S8 may have a drain coupled to the node N5, a gate to receive the gate signal GF, and a source coupled to the reference voltage line L22. The node N5 may be a coupling point between the source of the transistor S7 and the drain of the transistor S8.

The smoothing circuit 15 may be configured to smooth the voltage rectified by the rectifying circuit 14. The smoothing circuit 15 may include a choke inductor 16 and a capacitor 17. The choke inductor 16 may have a first end coupled to the voltage line L21A, and a second end coupled to a voltage line L21B. The capacitor 17 may have a first end coupled to the voltage line L21B, and a second end coupled to the reference voltage line L22. Although the choke inductor 16 may be provided on the voltage lines L21A and L21B in the example embodiment, this is non-limiting. In some embodiments, the choke inductor 16 may be provided on the reference voltage line L22, for example.

The voltage sensor 18 may be configured to detect a voltage at the voltage line L21B. The voltage sensor 18 may have a first end coupled to the voltage line L21, and a second end coupled to the reference voltage line L22. The voltage at the voltage line L21B with respect to a voltage at the reference voltage line L22 may be a voltage VL. The voltage sensor 18 may detect the voltage VL, and may supply a detection voltage VL2 corresponding to the voltage VL to the control circuit 40.

The auxiliary power supply circuit 20 may be configured to generate, based on the voltages VH and VL, various power supply voltages to be used in the electric power conversion apparatus 10, and to generate a detection voltage VH2 proportional to the voltage VH.

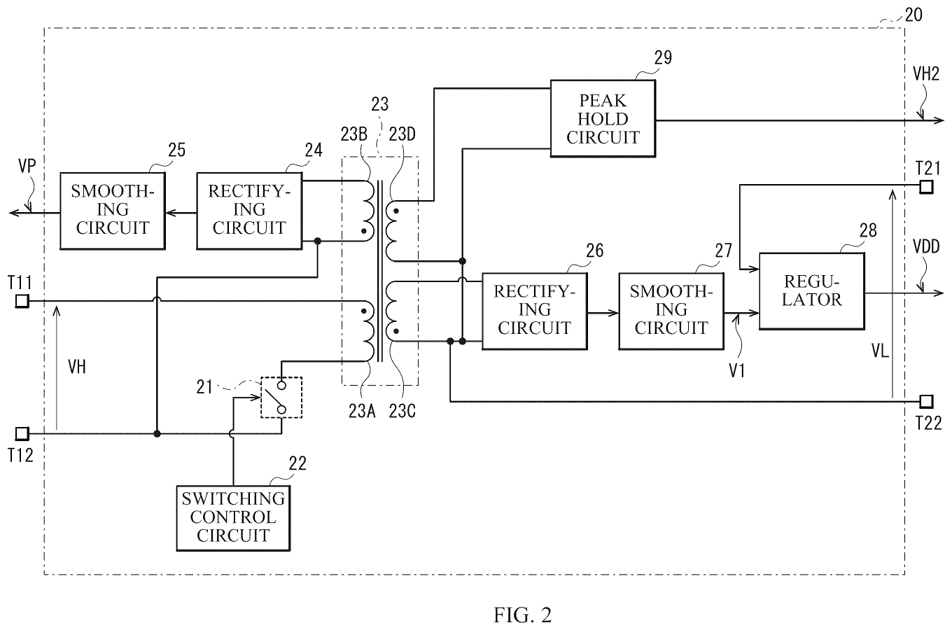

FIG. 2 illustrates a configuration example of the auxiliary power supply circuit 20. The auxiliary power supply circuit 20 may include a switching device 21, a switching control circuit 22, a transformer 23, a rectifying circuit 24, a smoothing circuit 25, a rectifying circuit 26, a smoothing circuit 27, a regulator 28, and a peak hold circuit 29.

The switching device 21 may have a first end coupled to a winding 23A of the transformer 23 to be described later, and a second end coupled to the terminal T12. The switching control circuit 22 may be configured to control an operation of the switching device 21.

The transformer 23 may include the winding 23A and windings 23B, 23C, and 23D. The windings 23A and 23B may be primary windings, and the windings 23C and 23D may be secondary windings. The winding 23A may have a first end coupled to the terminal T11, and a second end coupled to the first end of the switching device 21. The winding 23B may have a first end and a second end both coupled to the rectifying circuit 24. The first end of the winding 23B may be coupled to the terminal T12. The winding 23C may have a first end and a second end both coupled to the rectifying circuit 26. The winding 23D may have a first end and a second end both coupled to the peak hold circuit 29. The first end of the winding 23C and the first end of the winding 23D may be coupled to the terminal T22.

The rectifying circuit 24 may be configured to rectify an alternating-current voltage outputted from the winding 23B of the transformer 23. The auxiliary power supply circuit 20 may cause a pulse voltage generated through a switching operation performed by the switching device 21 to be transmitted from the winding 23A to the winding 23B. The winding 23B and the rectifying circuit 24 may transmit electric power in a flyback manner. The smoothing circuit 25 may be configured to smooth the voltage rectified by the rectifying circuit 24 and to output a smoothed direct-current voltage as a power supply voltage VP. The auxiliary power supply circuit 20 may supply the power supply voltage VP to the driving circuit 32, as illustrated in FIG. 1.

The rectifying circuit 26 may be configured to rectify an alternating-current voltage outputted from the winding 23C of the transformer 23. The auxiliary power supply circuit 20 may cause the pulse voltage generated through the switching operation performed by the switching device 21 to be transmitted from the winding 23A to the winding 23C. The winding 23C and the rectifying circuit 26 may transmit electric power in a flyback manner. The smoothing circuit 27 may be configured to smooth the voltage rectified by the rectifying circuit 26 and to output a smoothed direct-current voltage as a voltage V1.

The regulator 28 may be configured to generate a power supply voltage VDD, based on either the voltage V1 or the voltage VL. For example, the regulator 28 may generate the power supply voltage VDD, based on the voltage VL when the voltage V1 is lower than a desired voltage, and may generate the power supply voltage VDD, based on the voltage V1 when the voltage V1 is equal to the desired voltage. As illustrated in FIG. 1, the auxiliary power supply circuit 20 may supply the power supply voltage VDD to the control circuit 40.

The peak hold circuit 29 may be configured to perform a peak hold operation, based on an alternating-current voltage outputted from the winding 23D of the transformer 23, to thereby generate the detection voltage VH2 corresponding to a peak value of the alternating-current voltage. The auxiliary power supply circuit 20 may cause the pulse voltage generated through the switching operation performed by the switching device 21 to be transmitted from the winding 23A to the winding 23D. The winding 23D and the peak hold circuit 29 may transmit electric power in a forward manner. In other words, the detection voltage VH2 generated by the peak hold circuit 29 may be proportional to the voltage VH. As illustrated in FIG. 1, the auxiliary power supply circuit 20 may supply the detection voltage VH2 to the control circuit 40.

The driving circuit 32 may be configured to operate based on the power supply voltage VP supplied from the auxiliary power supply circuit 20, and to generate the gate signals GA to GD, respectively based on gate signals GA1 to GD1 supplied from the control circuit 40.

The driving circuit 34 may be configured to operate with the voltage VL as a power supply voltage, and to generate the gate signals GE and GF, respectively based on gate signals GE1 and GF1 supplied from the control circuit 40. Although the driving circuit 34 may operate with the voltage VL as the power supply voltage in the example embodiment, this is non-limiting. In some embodiments, the driving circuit 34 may operate based on the power supply voltage VDD generated by the auxiliary power supply circuit 20.

The control circuit 40 may be configured to control an operation of the electric power conversion apparatus 10 by controlling operations of the switching circuit 12 and the rectifying circuit 14, based on the detection voltage VH2 supplied from the auxiliary power supply circuit 20, the detection voltage VL2 supplied from the voltage sensor 18, and control data CTL supplied from the unillustrated system control processor. For example, the control circuit 40 may control the operation of the electric power conversion apparatus 10 by generating the gate signals GA1 to GF1, based on the detection voltages VH2 and VL2, and performing pulse width modulation (PWM) control, based on the gate signals GA1 to GF1. The control circuit 40 may operate based on the power supply voltage VDD supplied from the auxiliary power supply circuit 20. The control circuit 40 may include a microcontroller, for example. The control circuit 40 may subject the supplied detection voltages VH2 and VL2 to analog-to-digital (AD) conversion, and may perform processing, based on digital values obtained by the AD conversion. Hereinafter, as appropriate, the detection voltages VH2 and VL2 shall represent the digital values obtained by the AD conversion.

The terminals T21 and T22 may be configured to supply a voltage generated by the electric power conversion apparatus 10 to the low voltage battery BL. In the electric power conversion apparatus 10, the terminal T21 may be coupled to the voltage line L21B, and the terminal T22 may be coupled to the reference voltage line L22. Further, the terminal T21 may be coupled to a positive terminal of the low voltage battery BL, and the terminal T22 may be coupled to a negative terminal of the low voltage battery BL.

The low voltage battery BL may be configured to store the electric power supplied from the electric power conversion apparatus 10.

With this configuration, the electric power conversion system 1 may perform an electric power conversion operation of converting electric power supplied from the high voltage battery BH and supplying the converted electric power to the low voltage battery BL.

Further, the electric power conversion system 1 may also have a capability of performing what is called a precharge operation, that is, an operation of charging the capacitor 9 in a period before starting the electric power conversion operation described above. In the precharge operation, the switches SW1 and SW2 may be off, and the control circuit 40 may control the operations of the switching circuit 12 and the rectifying circuit 14 to thereby allow the electric power conversion system 1 to supply electric power of the low voltage battery BL to the capacitor 9. This helps to reduce, in the electric power conversion apparatus 10, an inrush current flowing from the high voltage battery BH to the capacitor 9 when the switches SW1 and SW2 are turned on to perform the electric power conversion operation.

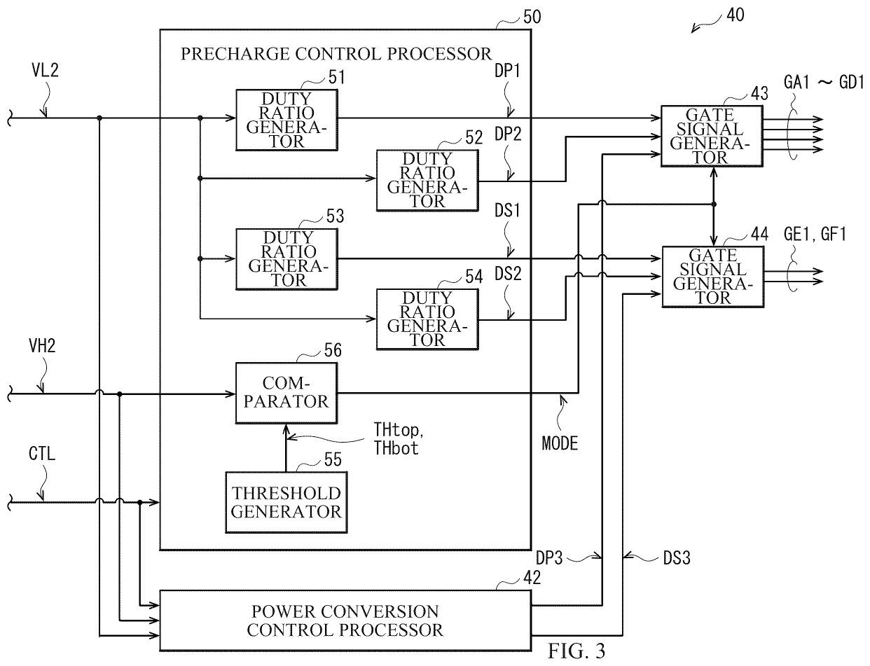

FIG. 3 illustrates a configuration example of the control circuit 40. The control circuit 40 may include a precharge control processor 50, a power conversion control processor 42, and gate signal generators 43 and 44.

The precharge control processor 50 may be configured to generate duty ratios DP1 and DP2 of the switching operation of the switching circuit 12 and duty ratios DS1 and DS2 of the switching operation of the rectifying circuit 14, based on the detection voltage VL2 corresponding to the voltage VL. Further, the precharge control processor 50 may have a capability of generating, based on the detection voltage VH2 corresponding to the voltage VH, a mode signal MODE indicating whether to use the duty ratios DP1 and DS1 or to use the duty ratios DP2 and DS2. The precharge control processor 50 may include duty ratio generators 51 to 54, a threshold generator 55, and a comparator 56. The precharge control processor 50 may perform processing, based on the voltage VL estimated based on the detection voltage VL2, and the voltage VH estimated based on the detection voltage VH2.

The duty ratio generator 51 may be configured to generate the duty ratio DP1 of the switching circuit 12, based on the detection voltage VL2 corresponding to the voltage VL, in a precharge period P1 and a voltage-maintaining period P2. For example, in the precharge period P1, the duty ratio generator 51 may so generate the duty ratio DP1 that the higher the voltage VL, the lower the duty ratio DP1. In the precharge period P1, the duty ratio generator 51 may generate the duty ratio DP1 to cause the duty ratio DP1 to gradually increase. In the voltage-maintaining period P2, the duty ratio generator 51 may so generate the duty ratio DP1 that the higher the voltage VL, the lower the duty ratio DP1.

The duty ratio generator 52 may be configured to generate the duty ratio DP2 of the switching circuit 12, based on the detection voltage VL2 corresponding to the voltage VL, and a target voltage command value VHtarget of the voltage VH, in the voltage-maintaining period P2. The target voltage command value VHtarget may be included in the control data CTL. The duty ratio DP2 may be lower than the duty ratio DP1 in the voltage-maintaining period P2. In the voltage-maintaining period P2, the duty ratio generator 52 may so generate the duty ratio DP2 that the higher the voltage VL, the lower the duty ratio DP2. Further, in the voltage-maintaining period P2, the duty ratio generator 52 may so generate the duty ratio DP2 that the higher the target voltage command value VHtarget, the higher the duty ratio DP2. The duty ratio generator 52 may maintain the duty ratio DP2 at zero in the precharge period P1.

The duty ratio generator 53 may be configured to generate the duty ratio DS1 of the rectifying circuit 14, based on the detection voltage VL2 corresponding to the voltage VL, in the precharge period P1 and the voltage-maintaining period P2. In the precharge period P1 and the voltage-maintaining period P2, the duty ratio DS1 may be higher than the duty ratio DP1. In the precharge period P1, the duty ratio generator 53 may so generate the duty ratio DS1 that the higher the voltage VL, the lower the duty ratio DS1. In the precharge period P1, the duty ratio generator 53 may generate the duty ratio DS1 to cause the duty ratio DS1 to gradually increase. In the voltage-maintaining period P2, the duty ratio generator 53 may so generate the duty ratio DS1 that the higher the voltage VL, the lower the duty ratio DS1.

The duty ratio generator 54 may be configured to generate the duty ratio DS2 of the rectifying circuit 14, based on the detection voltage VL2 corresponding to the voltage VL, and the target voltage command value VHtarget of the voltage VH included in the control data CTL, in the voltage-maintaining period P2. The duty ratio DS2 may be lower than the duty ratio DS1 in the voltage-maintaining period P2 and higher than the duty ratio DP2 in the voltage-maintaining period P2. In the voltage-maintaining period P2, the duty ratio generator 54 may so generate the duty ratio DS2 that the higher the voltage VL, the lower the duty ratio DS2. Further, in the voltage-maintaining period P2, the duty ratio generator 54 may so generate the duty ratio DS2 that the higher the target voltage command value VHtarget, the higher the duty ratio DS2. The duty ratio generator 54 may maintain the duty ratio DS2 at zero in the precharge period P1.

The threshold generator 55 may be configured to generate thresholds THtop and THbot, based on the target voltage command value VHtarget of the voltage VH included in the control data CTL, in the precharge period P1 and the voltage-maintaining period P2. The threshold THtop may be an upper threshold of the voltage VH, and the threshold THbot may be a lower threshold of the voltage VH.

FIG. 4 illustrates an example of the thresholds THtop and THbot. In the example embodiment, the threshold generator 55 may cause the threshold THtop to linearly increase with the passage of time from a timing t1 when the precharge period P1 starts onward, and may cause the threshold THtop to stop changing at and after a timing t3. The value of the threshold THtop at and after the timing t3 may be the target voltage command value VHtarget. Although the value of the threshold THtop at and after the timing t3 may be equal to the target voltage command value VHtarget in the example embodiment, this is non-limiting. In some embodiments, the value of the threshold THtop at and after the timing t3 may be equal to the target voltage command value VHtarget plus a value ΔV, i.e., VHtarget+ΔV Here, ΔV may be any value corresponding to the target voltage command value VHtarget. The threshold generator 55 may cause the threshold THbot to linearly increase with the passage of time from a timing t2 following the timing t1 onward, and may cause the threshold THbot to stop changing at and after a timing t4 following the timing t3.

As will be described later, in the precharge period P1 and the voltage-maintaining period P2, the control circuit 40 may control the operation of the electric power conversion apparatus 10 to cause the voltage VH to fall within a voltage range between the threshold THbot and the threshold THtop both inclusive. In the precharge period P1, the voltage VH may increase toward the target voltage command value VHtarget and, in the example embodiment, may reach the target voltage command value VHtarget at a timing t5. Thereafter, in the voltage-maintaining period P2, the voltage VH may be maintained at or near the target voltage command value VHtarget. After the voltage-maintaining period P2, the switches SW1 and SW2 may be turned on to cause the high voltage battery BH to be coupled to the capacitor 9. This causes a period in which the electric power conversion operation is performed, that is, an electric power conversion period, to start.

The comparator 56 illustrated in FIG. 3 may be configured to generate, in the precharge period P1 and the voltage-maintaining period P2, the mode signal MODE, based on the detection voltage VH2 corresponding to the voltage VH, by making comparisons between the voltage VH and the thresholds THtop and THbot.

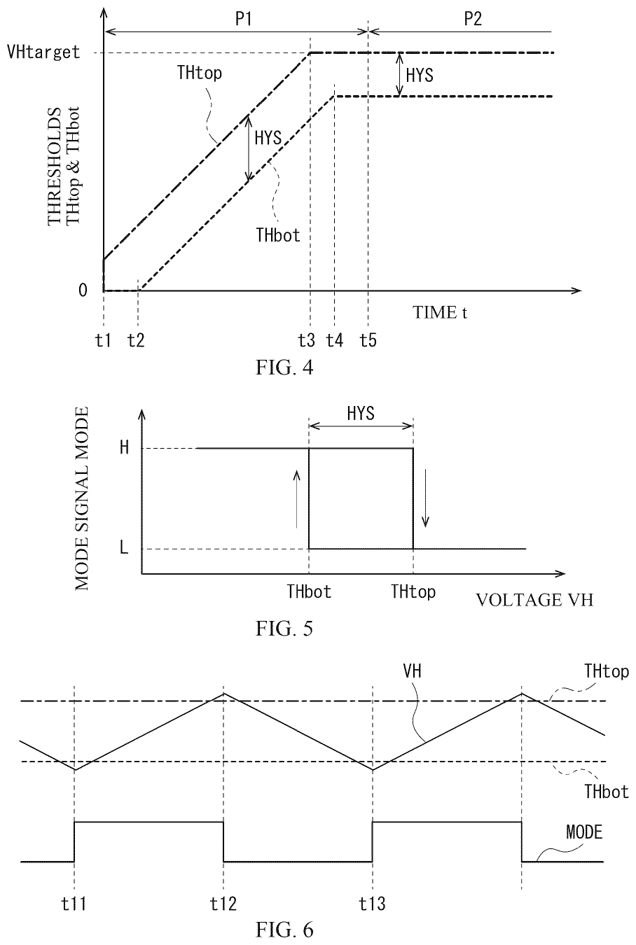

FIG. 5 illustrates a characteristic example of a comparison operation performed by the comparator 56. A comparison characteristic of the comparator 56 may exhibit a hysteresis characteristic in which a difference between the threshold THtop and the threshold THbot is defined as a hysteresis amount HYS.

When the voltage VH is lower than the threshold THbot, the comparator 56 may set the mode signal MODE to a high level. The voltage VH may thus gradually increase. Thereafter, when predetermined conditions are satisfied that include a condition that the voltage VH has reached the threshold THtop, the comparator 56 may change the mode signal MODE from the high level to a low level. In the example embodiment, the comparator 56 may change the mode signal MODE from the high level to the low level when the voltage VH has exceeded the threshold THtop five consecutive times, although this is non-limiting.

In contrast, when the voltage VH is higher than the threshold THtop, the comparator 56 may set the mode signal MODE to the low level. The voltage VH may thus gradually decrease. Thereafter, when predetermined conditions are satisfied that include a condition that the voltage VH has reached the threshold THbot, the comparator 56 may change the mode signal MODE from the low level to the high level. In the example embodiment, the comparator 56 may change the mode signal MODE from the low level to the high level when the voltage VH has fallen below the threshold THbot five consecutive times, although this is non-limiting.

FIG. 6 illustrates an operation example of the comparator 56. For example, at a timing t11, the mode signal MODE may be changed from the low level to the high level. As will be described later, once the mode signal MODE has changed to the high level, the control circuit 40 may generate the gate signals GA1 to GF1, based on the duty ratios DP1 and DS1. The electric power conversion apparatus 10 may perform a switching operation, based on the gate signals GA to GF corresponding to the gate signals GA1 to GF1, to supply electric power of the low voltage battery BL to the capacitor 9. This may cause the voltage VH to increase. After the voltage VH has reached the threshold THtop, the comparator 56 may change the mode signal MODE from the high level to the low level at a timing t12 when the voltage VH has exceeded the threshold THtop five consecutive times. Once the mode signal MODE has changed to the low level, the control circuit 40 may generate the gate signals GA1 to GF1, based on the duty ratios DP2 and DS2. The electric power conversion apparatus 10 may perform the switching operation, based on the gate signals GA to GF corresponding to the gate signals GA1 to GF1. This may cause the voltage VH to decrease. After the voltage VH has reached the threshold THbot, the comparator 56 may change the mode signal MODE from the low level to the high level at a timing t13 when the voltage VH has fallen below the threshold THbot five consecutive times. Subsequent operations may be performed in a similar manner.

In such a manner, in the precharge period P1 and the voltage-maintaining period P2, the comparator 56 may generate the mode signal MODE, based on the detection voltage VH2, by making comparisons between the voltage VH and the thresholds THtop and THbot.

The power conversion control processor 42 illustrated in FIG. 3 may be configured to generate, in the electric power conversion period, a duty ratio DP3 of the switching operation of the switching circuit 12 and a duty ratio DS3 of the switching operation of the rectifying circuit 14, based on the detection voltages VH2 and VL2, and the control data CTL supplied from the unillustrated system control processor.

The gate signal generator 43 may be configured to generate the gate signals GA1 to GD1, based on the duty ratios DP1 and DP2 generated by the precharge control processor 50, the duty ratio DP3 generated by the power conversion control processor 42, and the mode signal MODE generated by the precharge control processor 50. For example, in the precharge period P1 and the voltage-maintaining period P2, when the mode signal MODE is at the high level, the gate signal generator 43 may generate the gate signals GC1 and GD1, based on the duty ratio DP1, and may maintain the gate signals GA1 and GB1 at the low level. When the mode signal MODE is at the low level, the gate signal generator 43 may generate the gate signals GC1 and GD1, based on the duty ratio DP2, and may maintain the gate signals GA1 and GB1 at the low level. In the electric power conversion period, the gate signal generator 43 may generate the gate signals GA1 to GD1, based on the duty ratio DP3.

The gate signal generator 44 may be configured to generate the gate signals GE1 and GF1, based on the duty ratios DS1 and DS2 generated by the precharge control processor 50, the duty ratio DS3 generated by the power conversion control processor 42, and the mode signal MODE generated by the precharge control processor 50. For example, in the precharge period P1 and the voltage-maintaining period P2, when the mode signal MODE is at the high level, the gate signal generator 44 may generate the gate signals GE1 and GF1, based on the duty ratio DS1; and when the mode signal MODE is at the low level, the gate signal generator 44 may generate the gate signals GE1 and GF1, based on the duty ratio DS2. In the electric power conversion period, the gate signal generator 44 may generate the gate signals GE1 and GF1, based on the duty ratio DS3.

Here, the terminals T11 and T12 may correspond to a specific but non-limiting example of a “first electric power terminal” in one embodiment of the disclosure. The terminal T11 may correspond to a specific but non-limiting example of a “first coupling terminal” in one embodiment of the disclosure. The terminal T12 may correspond to a specific but non-limiting example of a “second coupling terminal” in one embodiment of the disclosure. The switching circuit 12 may correspond to a specific but non-limiting example of a “switching circuit” in one embodiment of the disclosure. The gate signals GA to GD may each correspond to a specific but non-limiting example of a “first driving signal” in one embodiment of the disclosure. The transformer 13 may correspond to a specific but non-limiting example of a “transformer” in one embodiment of the disclosure. The winding 13A may correspond to a specific but non-limiting example of a “first winding” in one embodiment of the disclosure. The winding 13B may correspond to a specific but non-limiting example of a “second winding” in one embodiment of the disclosure. The rectifying circuit 14 may correspond to a specific but non-limiting example of a “rectifying circuit” in one embodiment of the disclosure. The gate signals GE and GF may each correspond to a specific but non-limiting example of a “second driving signal” in one embodiment of the disclosure. The smoothing circuit 15 may correspond to a specific but non-limiting example of a “smoothing circuit” in one embodiment of the disclosure. The driving circuits 32 and 32 may correspond to a specific but non-limiting example of a “driving circuit” in one embodiment of the disclosure. The driving circuit 32 may correspond to a specific but non-limiting example of a “first driving circuit” in one embodiment of the disclosure. The driving circuit 34 may correspond to a specific but non-limiting example of a “second driving circuit” in one embodiment of the disclosure. The control circuit 40 may correspond to a specific but non-limiting example of a “control circuit” in one embodiment of the disclosure. The threshold THbot may correspond to a specific but non-limiting example of a “first threshold” in one embodiment of the disclosure. The threshold THtop may correspond to a specific but non-limiting example of a “second threshold” in one embodiment of the disclosure. The duty ratio DS1 may correspond to a specific but non-limiting example of a “first duty ratio” in one embodiment of the disclosure. The duty ratio DS2 may correspond to a specific but non-limiting example of a “second duty ratio” in one embodiment of the disclosure. The duty ratio DP1 may correspond to a specific but non-limiting example of a “third duty ratio” in one embodiment of the disclosure. The duty ratio DP2 may correspond to a specific but non-limiting example of a “fourth duty ratio” in one embodiment of the disclosure. The auxiliary power supply circuit 20 may correspond to a specific but non-limiting example of a “power supply circuit” in one embodiment of the disclosure. The power supply voltage VP may correspond to a specific but non-limiting example of a “power supply voltage” in one embodiment of the disclosure. The detection voltage VH2 may correspond to a specific but non-limiting example of a “detection voltage” in one embodiment of the disclosure. The high voltage battery BH may correspond to a specific but non-limiting example of a “first battery” in one embodiment of the disclosure. The capacitor 9 may correspond to a specific but non-limiting example of a “capacitor” in one embodiment of the disclosure. The switch SW1 may correspond to a specific but non-limiting example of a “first switch” in one embodiment of the disclosure. The switch SW2 may correspond to a specific but non-limiting example of a “second switch” in one embodiment of the disclosure. The low voltage battery BL may correspond to a specific but non-limiting example of a “second battery” in one embodiment of the disclosure.

### [Operation and Workings]

Next, a description will be given of operation and workings of the electric power conversion system 1 of the example embodiment.

### [Outline of Overall Operation]

First, an outline of an overall operation of the electric power conversion system 1 will be described with reference to FIG. 1. When the electric power conversion system 1 starts up, the switches SW1 and SW2 may be off. First, in the precharge period P1 and the voltage-maintaining period P2, the control circuit 40 may generate the gate signals GC1 to GF1, based on the detection voltage VH2 corresponding to the voltage VH, the detection voltage VL2 corresponding to the voltage VL, and the control data CTL, and may maintain the gate signals GA1 and GB1 at the low level. The electric power conversion apparatus 10 may perform the switching operation, based on the gate signals GA to GF corresponding to the gate signals GA1 to GF1, to supply electric power of the low voltage battery BL to the capacitor 9. As a result, the capacitor 9 may be charged, and the voltage VH may increase and be maintained at or near a voltage indicated by the target voltage command value VHtarget. Thereafter, in the electric power conversion period, the switches SW1 and SW2 may be turned on, and the control circuit 40 may generate the gate signals GA1 to GF1, based on the detection voltages VH2 and VL2. The electric power conversion apparatus 10 may perform the switching operation, based on the gate signals GA to GF corresponding to the gate signals GA1 to GF1 to convert electric power supplied from the high voltage battery BH, and may supply the converted electric power to the low voltage battery BL.

### [Detailed Operation]

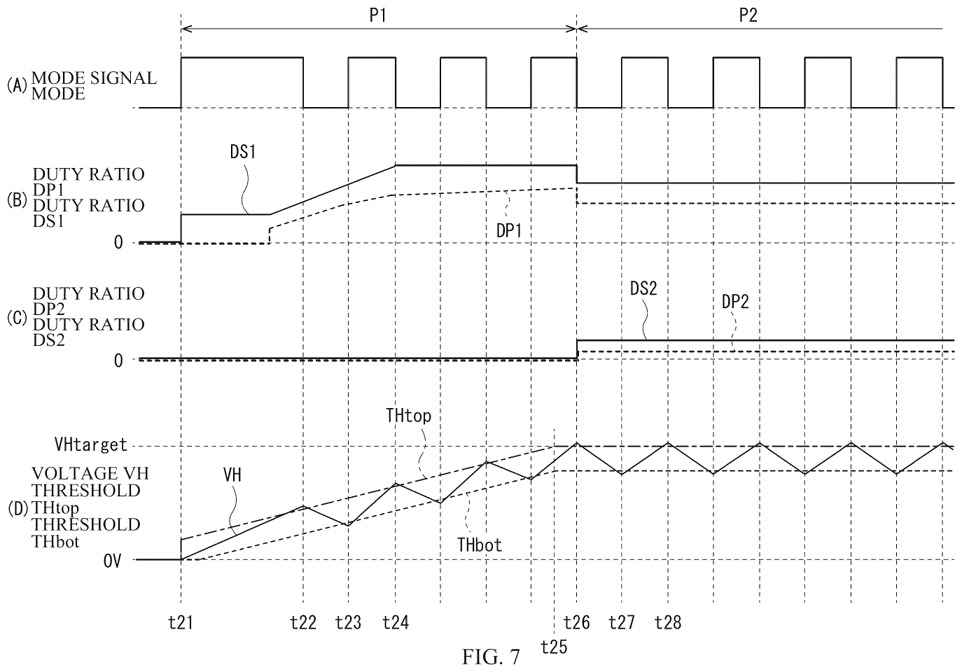

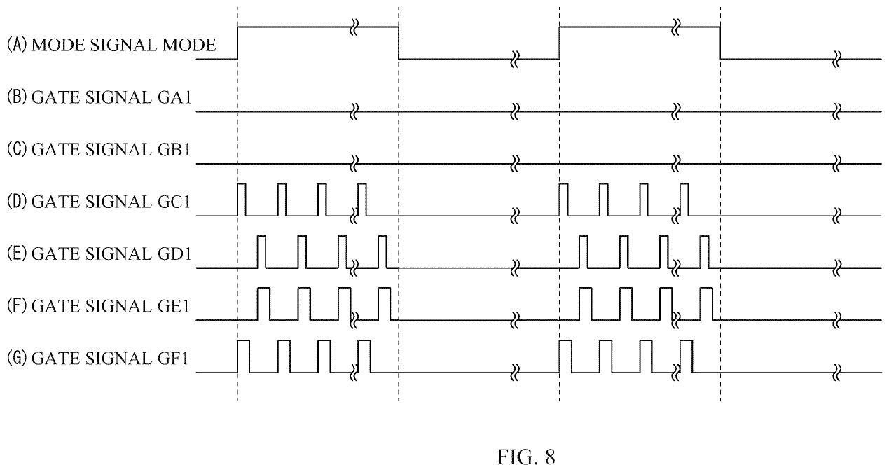

FIG. 7 illustrates an example of the precharge operation performed by the electric power conversion system 1. In FIG. 7, part (A) illustrates a waveform of the mode signal MODE, part (B) illustrates the duty ratios DP1 and DS1, part (C) illustrates the duty ratios DP2 and DS2, and part (D) illustrates a waveform and the thresholds THtop and THbot of the voltage VH.

In the example embodiment, the precharge period P1 may start at a timing t21. In the precharge period P1, the precharge control processor 50 may generate the duty ratios DP1 and DS1 to cause the duty ratios DP1 and DS1 to gradually increase, as illustrated in part (B) of FIG. 7. In the example embodiment, the precharge control processor 50 may generate the duty ratios DP1 and DS1 to cause the duty ratio DS1 to be 0.5 or less and cause the duty ratio DP1 to be less than or equal to the duty radio DS1, for example. The precharge control processor 50 may maintain the duty ratios DP2 and DS2 at zero, as illustrated in part (C) of FIG. 7.

The threshold generator 55 of the precharge control processor 50 may generate the thresholds THtop and THbot to cause the thresholds THtop and THbot to gradually increase in the precharge period P1, as illustrated in part (D) of FIG. 7. The comparator 56 may generate, based on the detection voltage VH2, the mode signal MODE as illustrated in part (A) of FIG. 7, by making comparisons between the voltage VH and the thresholds THtop and THbot. The gate signal generator 43 may generate the gate signals GA1 to GD1, based on the duty ratios DP1 and DP2 and the mode signal MODE. The gate signal generator 44 may generate the gate signals GE1 and GF1, based on the duty ratios DS1 and DS2 and the mode signal MODE.

FIG. 8 illustrates an example of the gate signals GA1 to GF1 in the precharge period P1. In FIG. 8, part (A) illustrates the waveform of the mode signal MODE, and parts (B) to (G) illustrate waveforms of the gate signals GA1 to GF1, respectively.

When the mode signal MODE is at the high level, the gate signal generator 43 may generate the gate signals GC1 and GD1 including pulses, based on the duty ratio DP1, and may maintain the gate signals GA1 and GB1 at the low level. Further, the gate signal generator 44 may generate the gate signals GE1 and GF1 including pulses, based on the duty ratio DS1.

When the mode signal MODE is at the low level, the gate signal generator 43 may maintain the gate signals GA1 to GD1 at the low level, based on the duty ratio DP2. For example, the duty ratio DP2 may be zero, as illustrated in part (C) of FIG. 7. Accordingly, when the mode signal MODE is at the low level, the gate signals GC1 and GD1 may be maintained at the low level, as illustrated in parts (D) and (E) of FIG. 8. The gate signal generator 44 may maintain the gate signals GE1 and GF1 at the low level, based on the duty ratio DS2. For example, the duty ratio DS2 may be zero, as illustrated in part (C) of FIG. 7. Accordingly, when the mode signal MODE is at the low level, the gate signals GE1 and GF1 may be maintained at the low level, as illustrated in parts (F) and (G) of FIG. 8.

As illustrated in FIG. 7, the electric power conversion system 1 may start the precharge operation at the timing t21. At the timing t21, the comparator 56 may change the mode signal MODE from the low level to the high level, as illustrated in part (A) of FIG. 7. The gate signal generator 43 may generate the gate signals GC1 and GD1 including pulses, based on the duty ratio DP1 illustrated in part (B) of FIG. 7. The gate signal generator 44 may generate the gate signals GE1 and GF1 including pulses, based on the duty ratio DS1 illustrated in part (B) of FIG. 7. The electric power conversion apparatus 10 may perform the switching operation, based on the gate signals GA to GF corresponding to the gate signals GA1 to GF1, to supply the electric power of the low voltage battery BL to the capacitor 9. This may cause the voltage VH to increase, as illustrated in part (D) of FIG. 7.

After the voltage VH has reached the threshold THtop, the comparator 56 may change the mode signal MODE from the high level to the low level, as illustrated in part (A) of FIG. 7, when the voltage VH has exceeded the threshold THtop five consecutive times at a timing t22 (part (D) of FIG. 7). The gate signal generator 43 may maintain the gate signals GC1 and GD1 at the low level, based on the duty ratio DP2 illustrated in part (C) of FIG. 7. The gate signal generator 44 may maintain the gate signals GE1 and GF1 at the low level, based on the duty ratio DS2 illustrated in part (C) of FIG. 7. This may cause the electric power conversion apparatus 10 to stop the switching operation, causing the voltage VH to decrease, as illustrated in part (D) of FIG. 7.

After the voltage VH has reached the threshold THbot, the comparator 56 may change the mode signal MODE from the low level to the high level, as illustrated in part (A) of FIG. 7, when the voltage VH has fallen below the threshold THbot five consecutive times at a timing t23 (part (D) of FIG. 7). The gate signal generator 43 may generate the gate signals GC1 and GD1 including pulses, based on the duty ratio DP1 illustrated in part (B) of FIG. 7. The gate signal generator 44 may generate the gate signals GE1 and GF1 including pulses, based on the duty ratio DS1 illustrated in part (B) of FIG. 7. The electric power conversion apparatus 10 may perform the switching operation, based on the gate signals GA to GF corresponding to the gate signals GA1 to GF1, to supply the electric power of the low voltage battery BL to the capacitor 9. This may cause the voltage VH to increase, as illustrated in part (D) of FIG. 7.

After the voltage VH has reached the threshold THtop, the comparator 56 may change the mode signal MODE from the high level to the low level, as illustrated in part (A) of FIG. 7, when the voltage VH has exceeded the threshold THtop five consecutive times at a timing t24 (part (D) of FIG. 7).

The electric power conversion system 1 may repeat the operations performed during a period from the timing t22 to the timing t24. In periods during which the mode signal MODE is at the high level, the gate signal generators 43 and 44 may generate the gate signals GC1 to GF1 including pulses. In periods during which the mode signal MODE is at the low level, the gate signal generators 43 and 44 may generate the gate signals GC1 to GF1 at the low level. In such a manner, the electric power conversion system 1 may perform the switching operation intermittently in the precharge period P1. As a result, the voltage VH may be controlled to repeat increasing and decreasing within or near the voltage range between the threshold THbot and the threshold THtop both inclusive. As illustrated in part (D) of FIG. 7, the thresholds THtop and THbot may each be set to gradually increase with the passage of time in the precharge period P1. The voltage VH may thus be led by the thresholds THtop and THbot to increase.

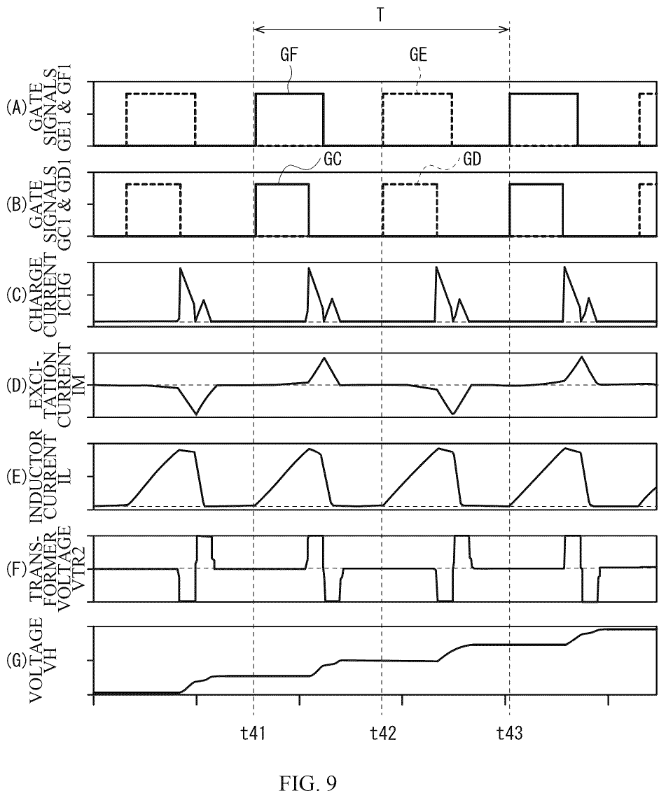

FIG. 9 illustrates a simulated waveform example of the precharge operation performed in a period, within the precharge period P1, during which the mode signal MODE is at the high level. Part (A) of FIG. 9 illustrates a waveform of each of the gate signals GE1 and GF1. Part (B) of FIG. 9 illustrates a waveform of each of the gate signals GC1 and GD1. Part (C) of FIG. 9 illustrates a waveform of a charge current ICHG, i.e., a current flowing into the capacitor 9. Part (D) of FIG. 9 illustrates a waveform of an excitation current IM of the transformer 13. Part (E) of FIG. 9 illustrates a waveform of an inductor current IL, i.e., a current flowing through the choke inductor 16 from the voltage line L21B to the voltage line L21A. Part (F) of FIG. 9 illustrates a waveform of a transformer voltage VTR2, i.e., a voltage of the winding 13B of the transformer 13 at the node N4 with respect to that at the node N5. Part (G) of FIG. 9 illustrates a waveform of the voltage VH. In FIG. 9, T represents a period of the switching operation.

In the precharge operation, the control circuit 40 may generate the gate signals GC1 and GD1, based on the duty ratio DP1, and may generate the gate signals GE1 and GF1, based on the duty ratio DS1. The duty ratio DP1 may represent a pulse width of each of the gate signals GC1 and GD1 where the period T, i.e., a duration from a timing t41 to a timing t43, is assumed to be “1”. The duty ratio DS1 may represent a pulse width of each of the gate signals GE1 and GF1 where the period T is assumed to be “1”. As illustrated in parts (A) and (B) of FIG. 9, the control circuit 40 may change the gate signals GC1 and GF1 from the low level to the high level at the timing t41. Thereafter, the control circuit 40 may change the gate signal GC1 from the high level to the low level at a timing when a time corresponding to the duty ratio DP1, i.e., the duty ratio DP1 multiplied by the period T, has elapsed from the timing t41, and may change the gate signal GF1 from the high level to the low level at a timing when a time corresponding to the duty ratio DS1, i.e., the duty ratio DS1 multiplied by the period T, has elapsed from the timing t41. Thereafter, the control circuit 40 may change the gate signals GD1 and GE1 from the low level to the high level at a timing t42. Thereafter, the control circuit 40 may change the gate signal GD1 from the high level to the low level at a timing when the time corresponding to the duty ratio DP1, i.e., the duty ratio DP1 multiplied by the period T, has elapsed from the timing t42, and may change the gate signal GE1 from the high level to the low level at a timing when the time corresponding to the duty ratio DS1, i.e., the duty ratio DS1 multiplied by the period T, has elapsed from the timing t42. Although not illustrated, the control circuit 40 may maintain the gate signals GA1 and GB1 at the low level. As a result, the charge current ICHG as illustrated in part (C) of FIG. 9 may flow into the capacitor 9 to cause the voltage VH to gradually increase, as illustrated in part (G) of FIG. 9.

In the example of FIG. 7, from a timing t25 onward, the threshold generator 55 may set the threshold THtop to a value indicated by the target voltage command value VHtarget, and may set the threshold THbot to a value corresponding to the target voltage command value VHtarget (part (D) of FIG. 7). Thereafter, at a timing t26, the voltage VH may have exceeded the threshold THtop, i.e., the target voltage command value VHtarget, five consecutive times (part (D) of FIG. 7). This may cause the precharge period P1 to end and cause the voltage-maintaining period P2 to start.

In the voltage-maintaining period P2, the precharge control processor 50 may set the duty ratios DP1, DS1, DP2, and DS2 to respective values corresponding to the voltage VL, as illustrated in parts (B) and (C) of FIG. 7. In the example embodiment, the precharge control processor 50 may set the duty ratio DP1 to a value slightly lower than a value immediately before the timing t26, and may set the duty ratio DS1 to a value slightly lower than a value immediately before the timing t26. Further, the precharge control processor 50 may set the duty ratio DP2 to a value lower than that of the duty ratio DP1, and may set the duty ratio DS2 to a value lower than that of the duty ratio DS1.

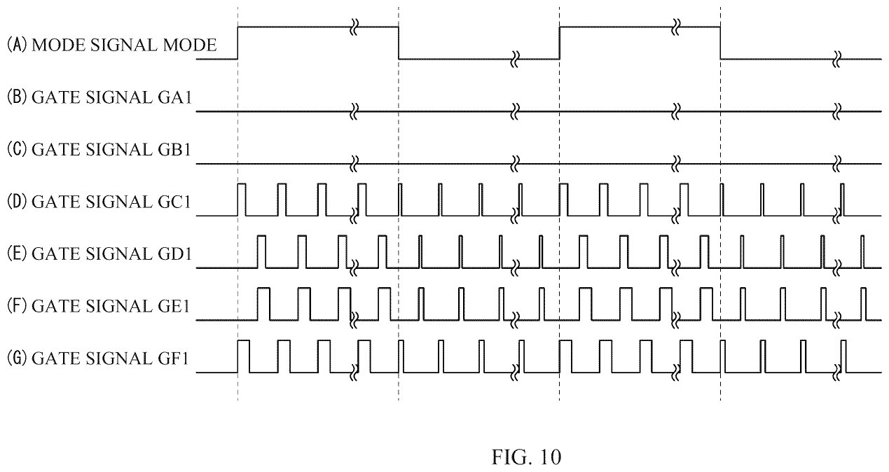

FIG. 10 illustrates an example of the gate signals GA1 to GF1 in the voltage-maintaining period P2. In FIG. 10, part (A) illustrates the waveform of the mode signal MODE, and parts (B) to (G) illustrate the waveforms of the gate signals GA1 to GF1, respectively.

When the mode signal MODE is at the high level, the gate signal generator 43 may generate the gate signals GC1 and GD1 including pulses, based on the duty ratio DP1, and may maintain the gate signals GA1 and GB1 at the low level. The gate signal generator 44 may generate the gate signals GE1 and GF1 including pulses, based on the duty ratio DS1.

When the mode signal MODE is at the low level, the gate signal generator 43 may generate the gate signals GC1 and GD1 including pulses, based on the duty ratio DP2, and may maintain the gate signals GA1 and GB1 at the low level. Because the duty ratio DP2 is lower than the duty ratio DP1 as illustrated in parts (B) and (C) of FIG. 7, the gate signal generator 43 may cause the gate signals GC1 and GD1 to have a narrower pulse width when the mode signal MODE is at the low level than when the mode signal MODE is at the high level, as illustrated in parts (D) and (E) of FIG. 10. The gate signal generator 44 may generate the gate signals GE1 and GF1 including pulses, based on the duty ratio DS2. Because the duty ratio DS2 is lower than the duty ratio DS1 as illustrated in parts (B) and (C) of FIG. 7, the gate signal generator 44 may cause the gate signals GE1 and GF1 to have a narrower pulse width when the mode signal MODE is at the low level than when the mode signal MODE is at the high level, as illustrated in parts (F) and (G) of FIG. 10.

As illustrated in FIG. 7, when the voltage VH has exceeded the threshold THtop five consecutive times at the timing t26 (part (D) of FIG. 7), the comparator 56 may change the mode signal MODE from the high level to the low level (part (A) of FIG. 7). The gate signal generator 43 may generate the gate signals GC1 and GD1 including pulses, based on the duty ratio DP2 (part (D) of FIG. 7), and the gate signal generator 44 may generate the gate signals GE1 and GF1 including pulses, based on the duty ratio DS2 (part (C) of FIG. 7). The electric power conversion apparatus 10 may perform the switching operation, based on the gate signals GA to GF corresponding to the gate signals GA1 to GF1. The duty ratios DP2 and DS2 may be low and allow low electric power to be transmitted from the secondary-side circuitry to the primary-side circuitry, thus causing the voltage VH to decrease (part (D) of FIG. 7). For example, in a period from the timing t26 to a timing t27, the electric power transmitted from the secondary-side circuitry to the primary-side circuitry may be lower than electric power consumed by circuits (the switching circuit 12 and the auxiliary power supply circuit 20) that operate on the electric power supplied from the terminals T11 and T12. The voltage VH may thus decrease.

After the voltage VH has reached the threshold THbot, the comparator 56 may change the mode signal MODE from the low level to the high level, as illustrated in part (A) of FIG. 7, when the voltage VH has fallen below the threshold THbot five consecutive times at the timing t27 (part (D) of FIG. 7). The gate signal generator 43 may generate the gate signals GC1 and GD1 including pulses, based on the duty ratio DP1 illustrated in part (B) of FIG. 7. The gate signal generator 44 may generate the gate signals GE1 and GF1 including pulses, based on the duty ratio DS1 illustrated in part (B) of FIG. 7. The electric power conversion apparatus 10 may perform the switching operation, based on the gate signals GA to GF corresponding to the gate signals GA1 to GF1, to supply the electric power of the low voltage battery BL to the capacitor 9. This may cause the voltage VH to increase, as illustrated in part (D) of FIG. 7. For example, in a period from the timing t27 to a timing t28, the electric power transmitted from the secondary-side circuitry to the primary-side circuitry may be higher than the electric power consumed by the circuits that operate on the electric power supplied from the terminals T11 and T12. The voltage VH may thus increase.

After the voltage VH has reached the threshold THtop, the comparator 56 may change the mode signal MODE from the high level to the low level, as illustrated in part (A) of FIG. 7, when the voltage VH has exceeded the threshold THtop five consecutive times at the timing t28 (part (D) of FIG. 7).

The electric power conversion system 1 may repeat the operations performed during a period from the timing t26 to the timing t28. In the periods during which the mode signal MODE is at the high level, the control circuit 40 may generate the gate signals GC1 to GF1 including pulses that are large in pulse width. This may cause the electric power transmitted from the secondary-side circuitry to the primary-side circuitry to be higher than the electric power consumed by the circuits that operate on the electric power supplied from the terminals T11 and T12, thus causing the voltage VH to increase. In the periods during which the mode signal MODE is at the low level, the control circuit 40 may generate the gate signals GC1 to GF1 including pulses that are small in pulse width. This may cause the electric power transmitted from the secondary-side circuitry to the primary-side circuitry to be lower than the electric power consumed by the circuits that operate on the electric power supplied from the terminals T11 and T12, thus causing the voltage VH to decrease. As a result, the voltage VH may be controlled to repeat increasing and decreasing within or near the voltage range between the threshold THbot and the threshold THtop both inclusive. In the voltage-maintaining period P2, the thresholds THtop and THbot may be set to respective values corresponding to the target voltage command value VHtarget, and the voltage VH may thus be maintained at or near a voltage indicated by the target voltage command value VHtarget.

The operations performed in the voltage-maintaining period P2 will now be described in more detail.

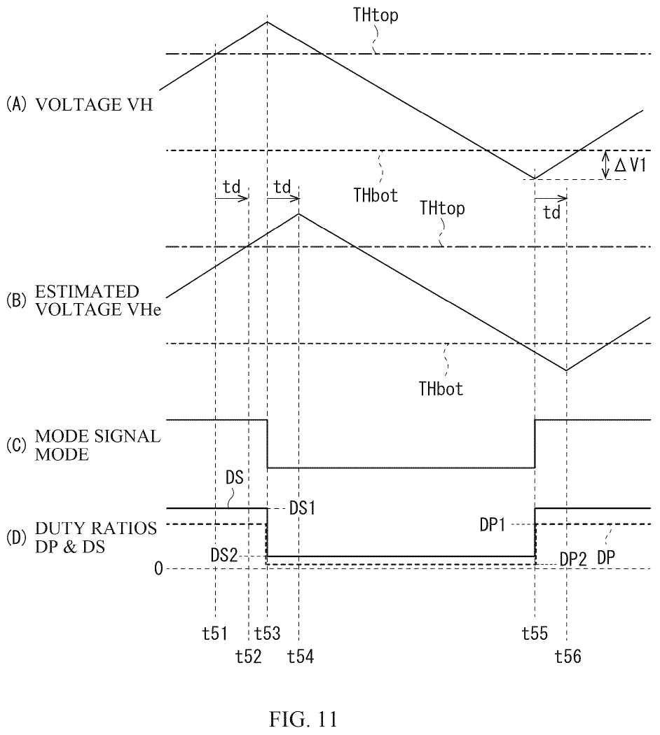

FIG. 11 illustrates an operation example of the electric power conversion system 1 in the voltage-maintaining period P2. In FIG. 11, part (A) illustrates the waveform of the voltage VH, part (B) illustrates a waveform of an estimated voltage VHe, i.e., the voltage VH estimated based on the detection voltage VH2, part (C) illustrates the waveform of the mode signal MODE, and part (D) illustrates the waveform of each of the duty ratio DP of the switching circuit 12 and the duty ratio DS of the rectifying circuit 14. For convenience of description, the thresholds THtop and THbot are also illustrated in parts (A) and (B) of FIG. 11. The duty ratio DP includes the duty ratio DP1 for a case where the mode signal MODE is at the high level and the duty ratio DP2 for a case where the mode signal MODE is at the low level. The duty ratio DS includes the duty ratio DS1 for the case where the mode signal MODE is at the high level and the duty ratio DS2 for the case where the mode signal MODE is at the low level.

In the illustrated example, prior to a timing t51, the mode signal MODE is at the high level and the voltage VH is increasing, as illustrated in parts (A) and (C) of FIG. 11. The auxiliary power supply circuit 20 may generate the detection voltage VH2, based on the voltage VH. Accordingly, the waveform of the estimated voltage VHe may be delayed relative to the waveform of the voltage VH by a delay time of the auxiliary power supply circuit 20, i.e., a time td, as illustrated in parts (A) and (B) of FIG. 11. For example, if the voltage VH exceeds the threshold THtop at the timing t51, the estimated voltage VHe may exceed the threshold THtop at a timing t52 that is delayed relative to the timing t51 by the time td.

For example, if the estimated voltage VHe has exceeded the threshold THtop five consecutive times at a timing t53 (part (B) of FIG. 11), the control circuit 40 may change the mode signal MODE from the high level to the low level at this timing t53, as illustrated in part (C) of FIG. 11. In accordance with this change, the control circuit 40 may change the duty ratio DP from the duty ratio DP1 to the duty ratio DP2 lower than the duty ratio DP1, and may change the duty ratio DS from the duty ratio DS1 to the duty ratio DS2 lower than the duty ratio DS1. Both the duty ratios DP and DS may thus be made lower to cause lower electric power to be transmitted from the secondary-side circuitry to the primary-side circuitry. This may cause the voltage VH to start decreasing at the timing t53, as illustrated in part (A) of FIG. 11. Thereafter, the estimated voltage VHe may start decreasing at a timing t54 that is delayed relative to the timing t53 by the time td. Thereafter, the voltage VH and the estimated voltage VHe may continue to decrease gradually.

Thereafter, if the estimated voltage VHe has fallen below the threshold THbot five consecutive times at a timing t55 (part (B) of FIG. 11), the control circuit 40 may change the mode signal MODE from the low level to the high level at this timing t55, as illustrated in part (C) of FIG. 11. In accordance with this change, the control circuit 40 may change the duty ratio DP from the duty ratio DP2 to the duty ratio DP1, and may change the duty ratio DS from the duty ratio DS2 to the duty ratio DS1. Both the duty ratios DP and DS may thus be made higher to cause higher electric power to be transmitted from the secondary-side circuitry to the primary-side circuitry. This may cause the voltage VH to start increasing at the timing t55, as illustrated in part (A) of FIG. 11. Thereafter, the estimated voltage VHe may start increasing at a timing t56 that is delayed relative to the timing t55 by the time td.

In this way, in the electric power conversion system 1, the switching circuit 12 and the rectifying circuit 14 may be caused to continuously perform the switching operations in the voltage-maintaining period P2 even if the mode signal MODE is set to the low level, as illustrated in FIG. 10. This helps to reduce a ripple of the voltage VH in the electric power conversion system 1, as described below in comparison with a reference example.

### [Reference Example]

An electric power conversion system according to a reference example will now be described. The reference example may differ from the foregoing example embodiment in switching operation in the voltage-maintaining period P2. For example, in the example embodiment, as illustrated in FIG. 10, the switching circuit 12 and the rectifying circuit 14 may continuously perform the switching operations in the periods during which the mode signal MODE is at the low level, whereas in the reference example, the switching circuit 12 and the rectifying circuit 14 may stop the switching operations in the periods during which the mode signal MODE is at the low level, as in the case of the precharge period P1 (FIG. 8).

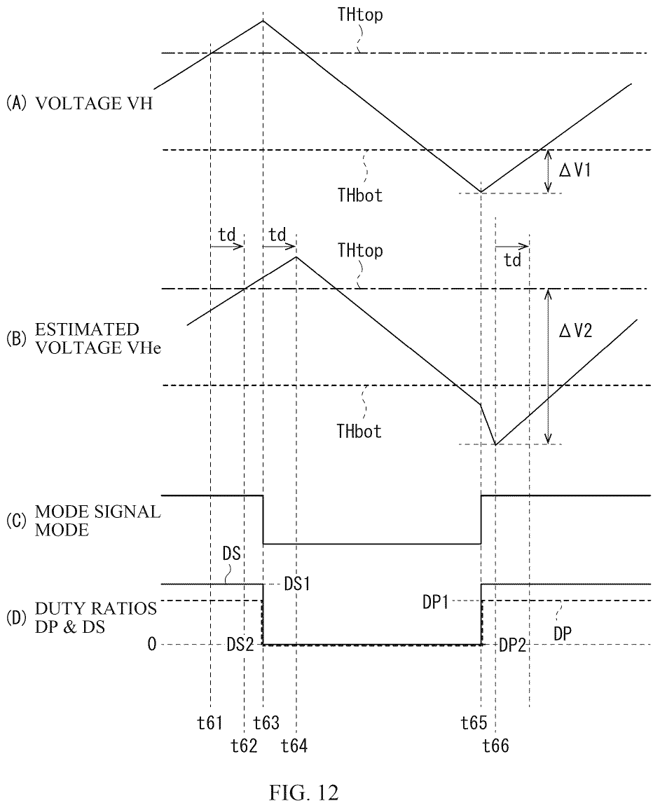

FIG. 12 illustrates an operation example of the electric power conversion system according to the reference example. In FIG. 12, part (A) illustrates the waveform of the voltage VH, part (B) illustrates the waveform of the estimated voltage VHe, i.e., the voltage VH estimated based on the detection voltage VH2, part (C) illustrates the waveform of the mode signal MODE, and part (D) illustrates the waveform of each of the duty ratio DP of the switching circuit 12 and the duty ratio DS of the rectifying circuit 14. FIG. 12 corresponds to FIG. 11 related to the example embodiment.

In the reference example, prior to a timing t61, the mode signal MODE is at the high level and the voltage VH is increasing, as illustrated in parts (A) and (C) of FIG. 12. The auxiliary power supply circuit 20 may generate the detection voltage VH2, based on the voltage VH. Accordingly, the waveform of the estimated voltage VHe may be delayed relative to the waveform of the voltage VH by a delay time of the auxiliary power supply circuit 20, i.e., the time td, as illustrated in parts (A) and (B) of FIG. 11. For example, if the voltage VH exceeds the threshold THtop at the timing t61, the estimated voltage VHe may exceed the threshold THtop at a timing t62 that is delayed relative to the timing t61 by the time td.

For example, if the estimated voltage VHe has exceeded the threshold THtop five consecutive times at a timing t63 (part (B) of FIG. 12), the control circuit 40 may change the mode signal MODE from the high level to the low level at this timing t63, as illustrated in part (C) of FIG. 12. In accordance with this change, the control circuit 40 may change the duty ratio DP from the duty ratio DP1 to zero, and may change the duty ratio DS from the duty ratio DS1 to zero. This may cause the switching circuit 12 and the rectifying circuit 14 to stop the switching operations, thus causing electric power transmission from the secondary-side circuitry to the primary-side circuitry to stop. As a result, the voltage VH may start decreasing at the timing t63, as illustrated in part (A) of FIG. 12. A gradient at which the voltage VH decreases may be greater than that in the case of the example embodiment (FIG. 11). For example, in the reference example, because the electric power transmission from the secondary-side circuitry to the primary-side circuitry has been stopped, the voltage VH may decrease more quickly than in the case of the example embodiment (FIG. 11). Thereafter, the estimated voltage VHe may start decreasing at a timing t64 that is delayed relative to the timing t63 by the time td.

Thereafter, if the estimated voltage VHe has fallen below the threshold THbot five consecutive times at a timing t65 (part (B) of FIG. 12), the control circuit 40 may change the mode signal MODE from the low level to the high level at this timing t65, as illustrated in part (C) of FIG. 12. In accordance with this change, the control circuit 40 may change the duty ratio DP from zero to the duty ratio DP1, and may change the duty ratio DS from zero to the duty ratio DS1. This may cause the switching circuit 12 and the rectifying circuit 14 to start the switching operations, causing the voltage VH to start increasing at the timing t65, as illustrated in part (A) of FIG. 12.

In this way, the switching circuit 12 may start the switching operation at the timing t65. The driving circuit 32 may drive the switching circuit 12. The auxiliary power supply circuit 20 may supply the power supply voltage VP to the driving circuit 32. Accordingly, once the switching circuit 12 has started the switching operation at the timing t65, the auxiliary power supply circuit 20 may be put under heavy load at the timing t65. This may cause, at the timing t65, for example, the power supply voltages VP and VDD to transiently decrease, and cause the detection voltage VH2 to transiently decrease. Due to such a transient decrease in the detection voltage VH2, the estimated voltage VHe may also transiently decrease, as illustrated in part (B) of FIG. 12. Thereafter, in the illustrated example, the estimated voltage VHe may start increasing at a timing t66.

In this way, in the electric power conversion system according to the reference example, the switching circuit 12 and the rectifying circuit 14 may stop the switching operations in the periods during which the mode signal MODE is at the low level. This results in a large gradient at which the voltage VH decreases. Accordingly, for example, a large voltage width ΔV1 results when the voltage VH falls below the threshold THbot, as illustrated in part (A) of FIG. 12. This causes the ripple of the voltage VH to be larger than that estimated from the thresholds THtop and THbot. Further, the transient decrease in the estimated voltage VHe at the timing t65 results in a large voltage width ΔV2 to the threshold THtop to which the estimated voltage VHe is to increase, as illustrated in part (B) of FIG. 12. This prolongs a duration over which the mode signal MODE is at the high level, thus causing a variation width of the voltage VH to be larger. As a result, the ripple of the voltage VH becomes larger than that estimated from the thresholds THtop and THbot.

In contrast, in the electric power conversion system 1 according to the example embodiment, as illustrated in FIG. 10, the switching circuit 12 and the rectifying circuit 14 may continuously perform the switching operations in the periods during which the mode signal MODE is at the low level and in the periods during which the mode signal MODE is at the high level. In the periods during which the mode signal MODE is at the low level, the control circuit 40 may set the duty ratio DP to the duty ratio DP2 lower than the duty ratio DP1, and may set the duty ratio DS to the duty ratio DS2 lower than the duty ratio DS1. Thus, the electric power conversion system 1 does not stop transmission of electric power from the secondary-side circuitry to the primary-side circuitry. This helps to cause the gradient at which the voltage VH decreases to be smaller. Accordingly, the electric power conversion system 1 allows for a smaller voltage width ΔV1 (part (A) of FIG. 11) when the voltage VH falls below the threshold THbot, and thus helps to reduce the ripple of the voltage VH.

Further, in the electric power conversion system 1, the switching circuit 12 and the rectifying circuit 14 may continuously perform the switching operations in the periods during which the mode signal MODE is at the low level and in the periods during which the mode signal MODE is at the high level. This involves no change in switching frequency, and the load on the auxiliary power supply circuit 20 thus remains changed. Accordingly, for example, unlike in the case of the reference example, the estimated voltage VHe is prevented from transiently decreasing. The electric power conversion system 1 thereby allows for a reduced variation width of the voltage VH. This helps to reduce the ripple of the voltage VH.

As described above, the electric power conversion system 1 includes a first electric power terminal (the terminals T11 and T12), the switching circuit 12, the transformer 13, the rectifying circuit 14, the smoothing circuit 15, a second electric power terminal (the terminals T21 and T22), the control circuit 40, and the driving circuits 32 and 34. The switching circuit 12 is coupled to the first electric power terminal (the terminals T11 and T12) and includes the switching devices configured to perform switching operations, based on first driving signals (the gate signals GA to GD). The transformer 13 includes a first winding (the winding 13A) and a second winding (the winding 13B). The first winding is coupled to the switching circuit 12. The rectifying circuit 14 is coupled to the second winding (the winding 13B) and includes the switching devices configured to perform the switching operations, based on second driving signals (the gate signals GE and GF). The smoothing circuit 15 is coupled to the rectifying circuit 14. The second electric power terminal including the terminals T21 and T22 is coupled to the smoothing circuit 15. The control circuit 40 is configured to control the operations of the switching circuit 12 and the rectifying circuit 14. The driving circuits 32 and 34 are configured to generate the first driving signals and the second driving signals, based on an instruction from the control circuit 40. The control circuit 40 is configured to: perform a first operation and a second operation alternately before causing electric power to be supplied from the first electric power terminal (the terminals T11 and T12) toward the second electric power terminal (the terminals T21 and T22); control, in the first operation, the operations of the switching circuit 12 and the rectifying circuit 14 to cause first electric power to be supplied from the second electric power terminal (the terminals T21 and T22) to the first electric power terminal (the terminals T11 and T12) to increase the voltage VH at the first electric power terminal (the terminals T11 and T12); and control, in the second operation, the operations of the switching circuit 12 and the rectifying circuit 14 to cause second electric power lower than the first electric power to be supplied from the second electric power terminal (the terminals T21 and T22) to the first electric power terminal (the terminals T11 and T12) to decrease the voltage VH at the first electric power terminal (the terminals T11 and T12). In this way, in the electric power conversion system 1, it is possible to supply the first electric power from the terminals T21 and T22 to the terminals T11 and T12 in the periods during which the mode signal MODE is at the high level, and to supply the second electric power lower than the first electric power from the terminals T21 and T22 to the terminals T11 and T12 in the periods during which the mode signal MODE is at the low level, for example. Accordingly, the electric power conversion system 1 helps to reduce the ripple of the voltage VH in the voltage-maintaining period P2.

In some embodiments, in the electric power conversion system 1, the control circuit 40 may be configured to start the first operation when predetermined conditions are satisfied that include a condition that the voltage VH at the first electric power terminal (the terminals T11 and T12) is lower in voltage value than a first threshold (the threshold THbot), and to start the second operation when predetermined conditions are satisfied that include a condition that the voltage VH at the first electric power terminal (the terminals T11 and T12) is higher in voltage value than a second threshold (the threshold THtop). For example, the control circuit 40 may be configured to start the first operation when the voltage VH has fallen below the threshold THbot five consecutive times, and to start the second operation when the voltage VH has exceeded the threshold THtop five consecutive times. The voltage VH may thus be controlled to repeat increasing and decreasing within or near the voltage range between the threshold THbot and the threshold THtop both inclusive. The electric power conversion system 1 thereby allows the voltage VH to be maintained and helps to reduce the ripple of the voltage VH.

In some embodiments, in the electric power conversion system 1, the control circuit 40 may be configured to set, in the first operation, the duty ratio DS of the second driving signal (each of the gate signals GE and GF) to a first duty ratio (the duty ratio DS1), and configured to set, in the second operation, the duty ratio DS of the second driving signal (each of the gate signals GE and GF) to a second duty ratio (the duty ratio DS2) lower than the first duty ratio (the duty ratio DS1). In some embodiments, the control circuit 40 may be configured to set, in the first operation, the duty ratio DP of the first driving signal (each of the gate signals GC and GD) to a third duty ratio (the duty ratio DP1) lower than the first duty ratio (the duty ratio DS1), and configured to set, in the second operation, the duty ratio DP of the first driving signal (each of the gate signals GC and GD) to a fourth duty ratio (the duty ratio DP2) lower than the second duty ratio (the duty ratio DS2) and the third duty ratio (the duty ratio DP1). This allows the electric power conversion system 1 to supply first electric power from the second electric power terminal (the terminals T21 and T22) to the first electric power terminal (the terminals T11 and T12) in the first operation, and to supply second electric power lower than the first electric power from the second electric power terminal (the terminals T21 and T22) to the first electric power terminal (the terminals T11 and T12) in the second operation. As a result, the electric power conversion system 1 helps to reduce the ripple of the voltage VH in the voltage-maintaining period P2.

### [Example Effects]

As described above, an electric power conversion apparatus or an electric power conversion system according to at least one embodiment of the disclosure includes a first electric power terminal, a switching circuit, a transformer, a rectifying circuit, a smoothing circuit, a second electric power terminal, a control circuit, and a driving circuit. The switching circuit is coupled to the first electric power terminal and includes a switching device. The switching device is configured to perform a switching operation, based on a first driving signal. The transformer includes a first winding and a second winding. The first winding is coupled to the switching circuit. The rectifying circuit is coupled to the second winding and includes a switching device. The switching device is configured to perform a switching operation, based on a second driving signal. The smoothing circuit is coupled to the rectifying circuit. The second electric power terminal is coupled to the smoothing circuit. The control circuit is configured to control operations of the switching circuit and the rectifying circuit. The driving circuit is configured to generate the first driving signal and the second driving signal, based on an instruction from the control circuit. The control circuit is configured to: perform a first operation and a second operation alternately before causing electric power to be supplied from the first electric power terminal toward the second electric power terminal; control, in the first operation, the operations of the switching circuit and the rectifying circuit to cause first electric power to be supplied from the second electric power terminal to the first electric power terminal to increase a voltage at the first electric power terminal; and control, in the second operation, the operations of the switching circuit and the rectifying circuit to cause second electric power lower than the first electric power to be supplied from the second electric power terminal to the first electric power terminal to decrease the voltage at the first electric power terminal. This makes it possible to reduce the ripple of the voltage at the first electric power terminal.

In some embodiments, the control circuit may be configured to start the first operation when predetermined conditions are satisfied that include a condition that the voltage at the first electric power terminal is lower in voltage value than a first threshold, and to start the second operation when predetermined conditions are satisfied that include a condition that the voltage at the first electric power terminal is higher in voltage value than a second threshold. This allows the voltage at the first electric power terminal to be maintained, and makes it possible to reduce the ripple of the voltage.

In some embodiments, the control circuit may be configured to set, in the first operation, a duty ratio of the second driving signal to a first duty ratio, and configured to set, in the second operation, the duty ratio of the second driving signal to a second duty ratio lower than the first duty ratio. In some embodiments, the control circuit may be configured to set, in the first operation, a duty ratio of the first driving signal to a third duty ratio lower than the first duty ratio, and configured to set, in the second operation, the duty ratio of the first driving signal to a fourth duty ratio lower than the second duty ratio and the third duty ratio. This makes it possible to reduce the ripple of the voltage at the first electric power terminal.

### Modification Example 1

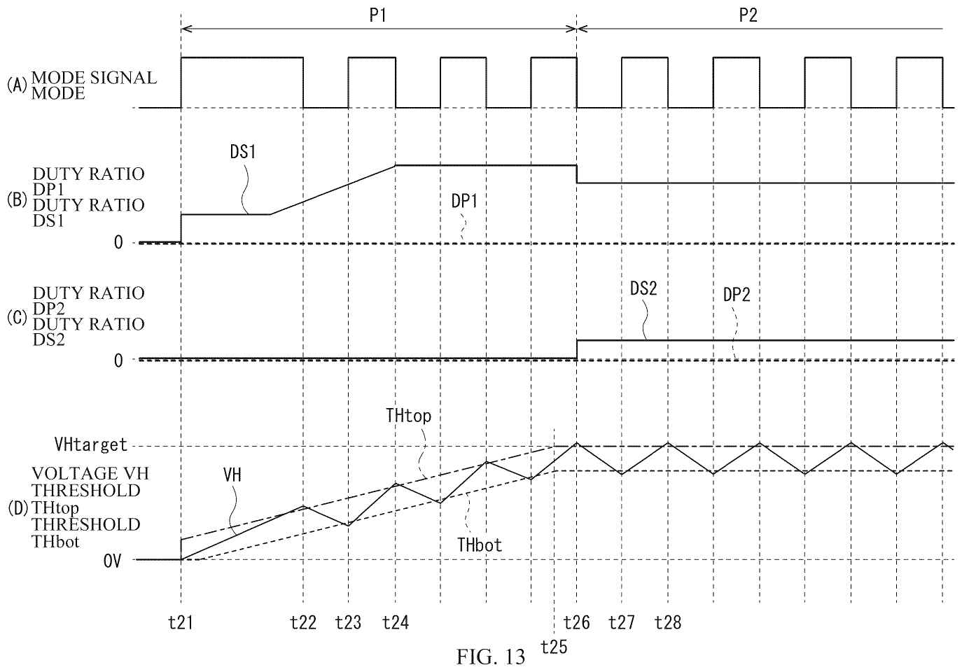

In the foregoing example embodiment, as illustrated in FIG. 7, the switching circuit 12 may perform the switching operation, based on the duty ratios DP1 and DP2 in the precharge period P1 and the voltage-maintaining period P2; however, this is non-limiting. In some embodiments, as illustrated in FIG. 13, the duty ratios DP1 and DP2 may be maintained at zero in the precharge period P1 and the voltage-maintaining period P2 to cause the switching circuit 12 to refrain from performing the switching operation. For example, when the voltage at the high voltage battery BH is not higher than a voltage obtained by the low voltage battery BL and the transformation ratio of the transformer 13, the switching circuit 12 may be caused to refrain from performing the switching operation in the precharge period P1 and the voltage-maintaining period P2 as described above.

### Modification Example 2

In the foregoing example embodiment, in the voltage-maintaining period P2, a switching frequency of the gate signals GC1 to GF1 in the periods during which the mode signal MODE is at the low level and a switching frequency of the gate signals GC1 to GF1 in the periods during which the mode signal MODE is at the high level may be made equal to each other, as illustrated in FIG. 10; however, this is non-limiting. In some embodiments, the switching frequency of the gate signals GC1 to GF1 in the periods during which the mode signal MODE is at the low level may be made lower than the switching frequency of the gate signals GC1 to GF1 in the periods during which the mode signal MODE is at the high level.

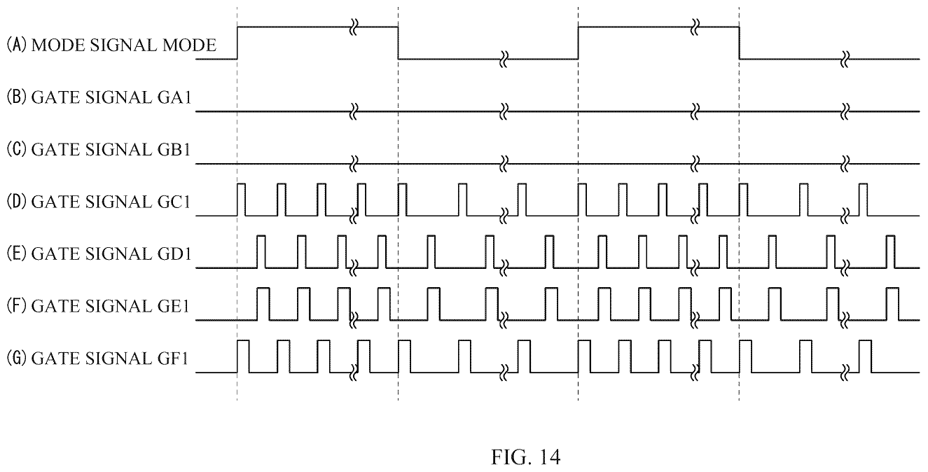

FIG. 14 illustrates an example of the gate signals GA1 to GF1 according to the present modification example. In FIG. 14, part (A) illustrates the waveform of the mode signal MODE, and parts (B) to (G) illustrate the waveforms of the gate signals GA1 to GF1, respectively. FIG. 14 corresponds to FIG. 10 related to the foregoing example embodiment.

In this example, the switching frequency of the gate signals GC1 to GF1 in the periods during which the mode signal MODE is at the low level may be made lower than the switching frequency of the gate signals GC1 to GF1 in the periods during which the mode signal MODE is at the high level. In this example, the gate signals GC1 to GF1 may have substantially constant pulse widths. Accordingly, the duty ratios DP and DS when the mode signal MODE is at the low level may be lower than the duty ratios DP and DS when the mode signal MODE is at the high level. In this case, the transistors S1 to S4 of the switching circuit 12 and the transistors S5 to S8 of the rectifying circuit 14 are turned on less frequently, which helps to reduce electric power to be transmitted from the secondary-side circuitry to the primary-side circuitry. The electric power conversion system according to the present modification example thus allows for a smaller gradient at which the voltage VH decreases. This helps to reduce the ripple of the voltage VH.

### Modification Example 3

In the foregoing example embodiment, in the voltage-maintaining period P2, the duty ratios DP and DS in the periods during which the mode signal MODE is at the low level may be made lower than the duty ratios DP and DS in the periods during which the mode signal MODE is at the high level, as illustrated in FIGS. 10 and 11; however, this is non-limiting. In some embodiments, the switching frequency in the periods during which the mode signal MODE is at the low level may be made higher than the switching frequency in the periods during which the mode signal MODE is at the high level. The present modification example will be described in detail below.

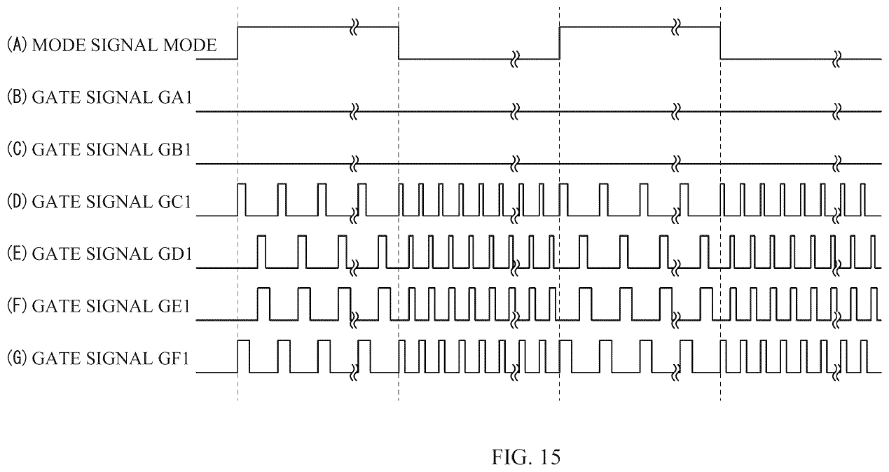

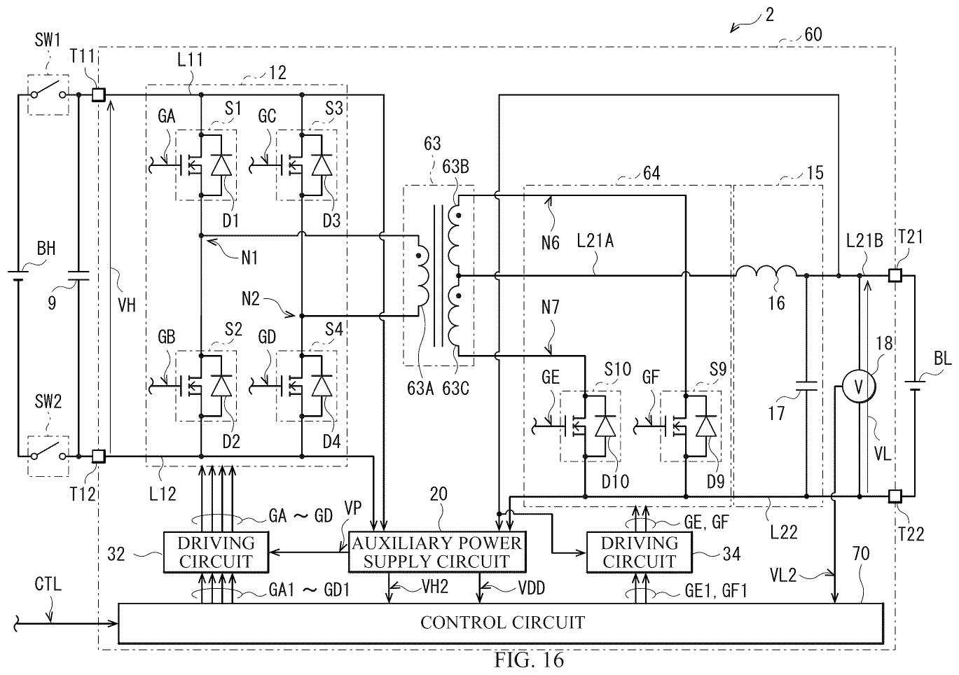

FIG. 15 illustrates an example of the gate signals GA1 to GF1 according to the present modification example. In FIG. 15, part (A) illustrates the waveform of the mode signal MODE, and parts (B) to (G) illustrate the waveforms of the gate signals GA1 to GF1, respectively. FIG. 15 corresponds to FIG. 10 related to the foregoing example embodiment.

In this example, when the mode signal MODE is at the low level, the control circuit 40 according to the present modification example may cause the switching frequency of the gate signals GC1 to GF1 to be higher than that when the mode signal MODE is at the high level. The duty ratios DP and DS when the mode signal MODE is at the low level may be the same as or different from the duty ratios DP and DS when the mode signal MODE is at the high level. By causing the switching frequency to be higher in the periods during which the mode signal MODE is at the low level in this way, the electric power to be transmitted from the secondary-side circuitry to the primary-side circuitry is allowed to be lower. The electric power conversion system according to the present modification example thus allows for a smaller gradient at which the voltage VH decreases. This helps to reduce the ripple of the voltage VH.

### Modification Example 4

In the foregoing example embodiment, as illustrated in FIG. 1, the full-bridge circuit may be employed to configure the rectifying circuit 14; however, this is non-limiting, and various types of circuits are applicable. For example, what is called a center-tapped electric power conversion system may be provided. The present modification example will be described in detail below.

FIG. 16 illustrates an example of an electric power conversion system 2 according to the present modification example. The electric power conversion system 2 includes an electric power conversion apparatus 60. The electric power conversion apparatus 60 includes a transformer 63, a rectifying circuit 64, and a control circuit 70.

The transformer 63 may include windings 63A, 63B, and 63C. The winding 63A may be the primary winding. The winding 63A may have a first end coupled to the node N1 in the switching circuit 12, and a second end coupled to the node N2 in the switching circuit 12. The winding 63B may be the secondary winding. The winding 63B may have a first end coupled to a node N6 in the rectifying circuit 64, and a second end coupled to a first end of the winding 63C and to the voltage line L21A. The winding 63C may be the secondary winding. The winding 63C may have the first end coupled to the second end of the winding 63B and to the voltage line L21A, and a second end coupled to a node N7 in the rectifying circuit 64.

The rectifying circuit 64 may include transistors S9 and S10. The transistors S9 and S10 may each include, for example, an N-type field-effect transistor. The transistors S9 and S10 may include body diodes D9 and D10, respectively. The transistor S9 may be provided on a path coupling the node N6 and the reference voltage line L22 to each other, and may be configured to couple the node N6 to the reference voltage line L22 by being turned on. The transistor S9 may have a drain coupled to the node N6, a gate to receive the gate signal GF, and a source coupled to the reference voltage line L22. The transistor S10 may be provided on a path coupling the node N7 and the reference voltage line L22 to each other, and may be configured to couple the node N7 to the reference voltage line L22 by being turned on. The transistor S10 may have a drain coupled to the node N7, a gate to receive the gate signal GE, and a source coupled to the reference voltage line L22.

The control circuit 70 may be configured to control an operation of the electric power conversion apparatus 60 by controlling the operations of the switching circuit 12 and the rectifying circuit 64, based on the detection voltage VH2 supplied from the auxiliary power supply circuit 20, the detection voltage VL2 supplied from the voltage sensor 18, and the control data CTL supplied from the unillustrated system control processor. For example, the control circuit 70 may control the operation of the electric power conversion apparatus 60 by generating the gate signals GA1 to GF1, based on the detection voltages VH2 and VL2, and performing PWM control, based on the gate signals GA1 to GF1.

Similarly, in the foregoing example embodiment, as illustrated in FIG. 1, the full-bridge circuit may be employed to configure the switching circuit 12; however, this is non-limiting, and various types of circuits are applicable.

### Other Modification Examples

Any two or more of the foregoing modification examples may be employed in combination. Further, the disclosure encompasses any possible combination of some or all of the various embodiments described herein and incorporated herein.

The disclosure has been described hereinabove with reference to the example embodiment and the modification examples. However, the disclosure is not limited thereto, and various modifications may be made.

For example, in the foregoing example embodiment, a step-down operation may be performed in the electric power conversion operation; however, this is non-limiting. In some embodiments, a step-up operation may be performed.

The effects described herein are mere examples, and effects of an embodiment of the disclosure are not limited thereto. Accordingly, any other effect may be obtained in relation to the embodiment of the disclosure.

An embodiment of the disclosure may have any of the following configurations.

(1)

An electric power conversion apparatus including:
a first electric power terminal;
a switching circuit coupled to the first electric power terminal and including a switching device, the switching device being configured to perform a switching operation, based on a first driving signal;
a transformer including a first winding and a second winding, the first winding being coupled to the switching circuit;
a rectifying circuit coupled to the second winding and including a switching device, the switching device being configured to perform a switching operation, based on a second driving signal;
a smoothing circuit coupled to the rectifying circuit;
a second electric power terminal coupled to the smoothing circuit;
a control circuit configured to control operations of the switching circuit and the rectifying circuit; and
a driving circuit configured to generate the first driving signal and the second driving signal, based on an instruction from the control circuit, in which
the control circuit is configured to:
   perform a first operation and a second operation alternately before causing electric power to be supplied from the first electric power terminal toward the second electric power terminal;
   control, in the first operation, the operations of the switching circuit and the rectifying circuit to cause first electric power to be supplied from the second electric power terminal to the first electric power terminal to increase a voltage at the first electric power terminal; and
   control, in the second operation, the operations of the switching circuit and the rectifying circuit to cause second electric power lower than the first electric power to be supplied from the second electric power terminal to the first electric power terminal to decrease the voltage at the first electric power terminal.
      (2)

The electric power conversion apparatus according to (1), in which the control circuit is configured to:
start the first operation when predetermined conditions are satisfied, the predetermined conditions including a condition that the voltage at the first electric power terminal is lower in voltage value than a first threshold; and
start the second operation when predetermined conditions are satisfied, the predetermined conditions including a condition that the voltage at the first electric power terminal is higher in voltage value than a second threshold.
   (3)

The electric power conversion apparatus according to (1) or (2), in which the control circuit is configured to:
set, in the first operation, a duty ratio of the second driving signal to a first duty ratio; and
set, in the second operation, the duty ratio of the second driving signal to a second duty ratio lower than the first duty ratio.
   (4)

The electric power conversion apparatus according to (3), in which the control circuit is configured to:
set, in the first operation, a duty ratio of the first driving signal to a third duty ratio lower than the first duty ratio; and
set, in the second operation, the duty ratio of the first driving signal to a fourth duty ratio lower than the second duty ratio and the third duty ratio.
   (5)

The electric power conversion apparatus according to (4), in which the control circuit is configured to:
set, in the first operation, a switching frequency of each of the first driving signal and the second driving signal to a first switching frequency; and
set, in the second operation, the switching frequency of each of the first driving signal and the second driving signal to a second switching frequency lower than the first switching frequency.
   (6)

The electric power conversion apparatus according to (1) or (2), in which the control circuit is configured to:
set, in the first operation, a switching frequency of each of the first driving signal and the second driving signal to a first switching frequency; and
set, in the second operation, the switching frequency of each of the first driving signal and the second driving signal to a second switching frequency higher than the first switching frequency.
   (7)

The electric power conversion apparatus according to (6), in which the control circuit is configured to:
set, in the first operation, a duty ratio of the second driving signal to a first duty ratio; and
set, in the second operation, the duty ratio of the second driving signal to a second duty ratio lower than the first duty ratio.
   (8)

The electric power conversion apparatus according to any one of (1) to (7), further including a power supply circuit configured to generate a power supply voltage, based on the voltage at the first electric power terminal and configured to generate a detection voltage corresponding to the voltage at the first electric power terminal, in which
the driving circuit includes:
a first driving circuit configured to generate the first driving signal, and to operate based on the power supply voltage; and
a second driving circuit configured to generate the second driving signal.
   (9)

An electric power conversion system including:
a first battery including a first terminal and a second terminal;
a capacitor including a first terminal and a second terminal;
a first switch provided on a path coupling the first terminal of the first battery and the first terminal of the capacitor to each other;
a second switch provided on a path coupling the second terminal of the first battery and the second terminal of the capacitor to each other;
an electric power conversion apparatus; and
a second battery,
the electric power conversion apparatus including:
   a first electric power terminal including a first coupling terminal and a second coupling terminal, the first coupling terminal being coupled to the first terminal of the capacitor, the second coupling terminal being coupled to the second terminal of the capacitor;
   a switching circuit coupled to the first electric power terminal and including a switching device, the switching device being configured to perform a switching operation, based on a first driving signal;
   a transformer including a first winding and a second winding, the first winding being coupled to the switching circuit;
   a rectifying circuit coupled to the second winding and including a switching device, the switching device being configured to perform a switching operation, based on a second driving signal;
   a smoothing circuit coupled to the rectifying circuit;
   a second electric power terminal coupled to the smoothing circuit and to the second battery;
   a control circuit configured to control operations of the switching circuit and the rectifying circuit; and
   a driving circuit configured to generate the first driving signal and the second driving signal, based on an instruction from the control circuit, in which
the control circuit is configured to:
   perform a first operation and a second operation alternately before causing electric power to be supplied from the first electric power terminal toward the second electric power terminal;
   control, in the first operation, the operations of the switching circuit and the rectifying circuit to cause first electric power to be supplied from the second electric power terminal to the first electric power terminal to increase a voltage at the first electric power terminal; and
   control, in the second operation, the operations of the switching circuit and the rectifying circuit to cause second electric power lower than the first electric power to be supplied from the second electric power terminal to the first electric power terminal to decrease the voltage at the first electric power terminal.

An electric power conversion apparatus and an electric power conversion system according to at least one embodiment of the disclosure each make it possible to reduce a ripple of a voltage of a capacitor.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

What is claimed is:

1. An electric power conversion apparatus comprising:
a first electric power terminal;
a switching circuit coupled to the first electric power terminal and including a switching device, the switching device being configured to perform a switching operation, based on a first driving signal;
a transformer including a first winding and a second winding, the first winding being coupled to the switching circuit;
a rectifying circuit coupled to the second winding and including a switching device, the switching device being configured to perform a switching operation, based on a second driving signal;
a smoothing circuit coupled to the rectifying circuit;
a second electric power terminal coupled to the smoothing circuit;
a control circuit configured to control operations of the switching circuit and the rectifying circuit; and
a driving circuit configured to generate the first driving signal and the second driving signal, based on an instruction from the control circuit, wherein
the control circuit is configured to:
perform a first operation and a second operation alternately before causing electric power to be supplied from the first electric power terminal toward the second electric power terminal;
control, in the first operation, the operations of the switching circuit and the rectifying circuit to cause first electric power to be supplied from the second electric power terminal to the first electric power terminal to increase a voltage at the first electric power terminal; and
control, in the second operation, the operations of the switching circuit and the rectifying circuit to cause second electric power lower than the first electric power to be supplied from the second electric power terminal to the first electric power terminal to decrease the voltage at the first electric power terminal.

2. The electric power conversion apparatus according to claim 1, wherein the control circuit is configured to:
start the first operation when predetermined conditions are satisfied, the predetermined conditions including a condition that the voltage at the first electric power terminal is lower in voltage value than a first threshold; and
start the second operation when predetermined conditions are satisfied, the predetermined conditions including a condition that the voltage at the first electric power terminal is higher in voltage value than a second threshold.

3. The electric power conversion apparatus according to claim 1, wherein the control circuit is configured to:
set, in the first operation, a duty ratio of the second driving signal to a first duty ratio; and
set, in the second operation, the duty ratio of the second driving signal to a second duty ratio lower than the first duty ratio.

4. The electric power conversion apparatus according to claim 3, wherein the control circuit is configured to:
set, in the first operation, a duty ratio of the first driving signal to a third duty ratio lower than the first duty ratio; and
set, in the second operation, the duty ratio of the first driving signal to a fourth duty ratio lower than the second duty ratio and the third duty ratio.

5. The electric power conversion apparatus according to claim 4, wherein the control circuit is configured to:
set, in the first operation, a switching frequency of each of the first driving signal and the second driving signal to a first switching frequency; and
set, in the second operation, the switching frequency of each of the first driving signal and the second driving signal to a second switching frequency lower than the first switching frequency.

6. The electric power conversion apparatus according to claim 1, wherein the control circuit is configured to:
set, in the first operation, a switching frequency of each of the first driving signal and the second driving signal to a first switching frequency; and
set, in the second operation, the switching frequency of each of the first driving signal and the second driving signal to a second switching frequency higher than the first switching frequency.

7. The electric power conversion apparatus according to claim 6, wherein the control circuit is configured to:
set, in the first operation, a duty ratio of the second driving signal to a first duty ratio; and
set, in the second operation, the duty ratio of the second driving signal to a second duty ratio lower than the first duty ratio.

8. The electric power conversion apparatus according to claim 1, further comprising a power supply circuit configured to generate a power supply voltage, based on the voltage at the first electric power terminal and configured to generate a detection voltage corresponding to the voltage at the first electric power terminal, wherein
the driving circuit includes:
a first driving circuit configured to generate the first driving signal, and to operate based on the power supply voltage; and
a second driving circuit configured to generate the second driving signal.

9. An electric power conversion system comprising:
a first battery including a first terminal and a second terminal;
a capacitor including a first terminal and a second terminal;
a first switch provided on a path coupling the first terminal of the first battery and the first terminal of the capacitor to each other;
a second switch provided on a path coupling the second terminal of the first battery and the second terminal of the capacitor to each other;
an electric power conversion apparatus; and
a second battery,
the electric power conversion apparatus including:
a first electric power terminal including a first coupling terminal and a second coupling terminal, the first coupling terminal being coupled to the first terminal of the capacitor, the second coupling terminal being coupled to the second terminal of the capacitor;
a switching circuit coupled to the first electric power terminal and including a switching device, the switching device being configured to perform a switching operation, based on a first driving signal;
a transformer including a first winding and a second winding, the first winding being coupled to the switching circuit;
a rectifying circuit coupled to the second winding and including a switching device, the switching device being configured to perform a switching operation, based on a second driving signal;
a smoothing circuit coupled to the rectifying circuit;
a second electric power terminal coupled to the smoothing circuit and to the second battery;
a control circuit configured to control operations of the switching circuit and the rectifying circuit; and
a driving circuit configured to generate the first driving signal and the second driving signal, based on an instruction from the control circuit, wherein
the control circuit is configured to:
perform a first operation and a second operation alternately before causing electric power to be supplied from the first electric power terminal toward the second electric power terminal;
control, in the first operation, the operations of the switching circuit and the rectifying circuit to cause first electric power to be supplied from the second electric power terminal to the first electric power terminal to increase a voltage at the first electric power terminal; and
control, in the second operation, the operations of the switching circuit and the rectifying circuit to cause second electric power lower than the first electric power to be supplied from the second electric power terminal to the first electric power terminal to decrease the voltage at the first electric power terminal.
